(19) United States
(12) Patent Application Publication
(10) Pub. No.: US 2026/0310470 A1
(43) Pub. Date: Oct. 8, 2026

(54) SYSTEMS AND METHODS FOR MACHINE LEARNING-BASED CONFIGURATION, REPAIR, AND EXECUTION OF SOFTWARE CODE USING LOG ANALYSIS AND PRIOR CONFIGURATION REUSE

(71) Applicants: Constructor Technology AG, Schaffhausen (CH); Constructor Education and Research Genossenschaft, Schaffhausen (CH); Constructor Labs gGmbH, Bremen (DE)

(72) Inventors: Alexander Tormasov, Busingen am Hochrhein (DE); Giancarlo Succi, Genova (IT); Nikolay Dobrovolskiy, Alanya (TR); Stanislav Protasov, Singapore (SG); Laurent Dedenis, Geneve (CH); Serg Bell, Singapore (SG)

(21) Appl. No.: 19/714,889

(22) Filed: Jun. 22, 2026

Related U.S. Application Data
(63) Continuation-in-part of application No. 19/084,872, filed on Mar. 20, 2025.

(51) Int. Cl. G06F 9/445; G06F 11/3668; G06F 16/334

(52) U.S. Cl. CPC G06F 9/44505; G06F 11/3688; G06F 16/334

(57) ABSTRACT

Disclosed are systems and methods for automated reconfiguration of computing environments. An example method includes: executing software code within a computing environment; collecting a first execution log generated during the execution of the software code; processing the first execution log with a first trained machine learning model (MLM) to identify configuration-related failures in the computing environment; querying a database storing a plurality of historical execution logs associated with prior executions and corresponding configuration repair sets to select a historical log having a statistical similarity to the first execution log using a second trained MLM; generating a current configuration repair set for the computing environment using a third trained MLM configured to adapt a configuration repair set corresponding to the selected historical log to a current environment state of the computing environment; and automatically reconfiguring the computing environment by applying the current configuration repair set to resolve the identified configuration-related failures.

### CROSS-REFERENCE TO RELATED APPLICATIONS

The present disclosure is a continuation-in-part of U.S. Patent Application No. 19/084,872, filed on Mar. 20, 2025, the entire disclosure of which is incorporated herein by reference.

### FIELD OF TECHNOLOGY

The present disclosure relates to the field of machine learning, and, more specifically, to systems and methods for machine learning (ML)-based configuration, repair, and execution of software code using log analysis and prior configuration reuse.

### BACKGROUND

Executing arbitrary software code in a computing environment typically requires substantial manual effort to configure the correct software dependencies, hardware resources, and/or runtime parameters. When execution fails due to configuration errors (e.g., missing libraries, version mismatches, or incorrect environment variables), diagnosing and resolving these failures can be time-consuming and require significant technical expertise. Related approaches often rely on static documentation or user intervention, which are insufficient for handling the complexity and variability of modern software projects.

### SUMMARY

This disclosure addresses these challenges by providing systems and methods that employ machine learning models to automatically configure computing environments for executing software code, diagnose configuration-related failures from execution logs, and iteratively repair the environment by leveraging a database of prior projects containing historical execution logs and associated configuration changes. By applying a convergence criterion based on an error-volume metric, the system ensures that only configuration changes that reduce the overall severity and number of errors are accepted. Additional machine learning models (MLMs) infer new runtime and/or input parameters from static code analysis, external sources such as code repositories and question-and-answer websites, and a knowledge base of configuration information extracted from repository history. This provides a self-improving system that can automatically configure, troubleshoot, and repair the environment required to execute software code without requiring detailed documentation or manual intervention, thereby reducing setup time, minimizing human error, and improving the reproducibility and reliability of software execution across diverse computing environments.

An aspect of this disclosure provides a method for automated reconfiguration of computing environments. The method includes: executing software code within a computing environment; collecting a first execution log generated during the execution of the software code; processing the first execution log with a first trained MLM to identify configuration-related failures in the computing environment; querying a database storing a plurality of historical execution logs associated with prior executions and corresponding configuration repair sets to select a historical log having a statistical similarity to the first execution log using a second trained MLM; generating a current configuration repair set for the computing environment using a third trained MLM configured to adapt a configuration repair set corresponding to the selected historical log to a current environment state of the computing environment; and automatically reconfiguring the computing environment by applying the current configuration repair set to resolve the identified configuration-related failures.

In an aspect, the reconfiguring the computing environment includes: modifying the computing environment based on the current configuration repair set; re-executing the software code within the modified computing environment to collect a second execution log; computing a first error-volume metric from the first execution log and a second error-volume metric from the second execution log; determining a baseline configuration repair set based on a comparison between the first error-volume metric and the second error-volume metric; and further reconfiguring the computing environment based on the baseline configuration repair set until the software code executes successfully or a termination condition is met.

In an aspect, the determining the baseline configuration repair set includes: when the second error-volume metric is less than the first error-volume metric, determining the current configuration repair set as the baseline configuration repair set; and when the second error-volume metric is not less than the first error-volume metric, determining a subsequent configuration repair set as the baseline configuration repair set, the subsequent configuration repair set being generated by the third trained MLM.

In an aspect, at least one of the first and second error-volume metrics includes at least one of a number of errors, a severity of errors, or a distribution of error types.

In an aspect, at least one of the first and second error-volume metrics is calculated by: assigning error-volume scores to respective error messages in the execution log by using a fourth trained MLM and based on an information source including at least one of an online documentation, a benchmark repository, or a question-and-answer website; and aggregating the error-volume scores to obtain the error-volume metric.

In an aspect, the modifying the computing environment includes modifying at least one of: an installed software package; a version of an interpreter or a library; or an environment variable.

In an aspect, the method further includes: for each of the prior executions, storing in the database an indication whether a configuration repair set corresponding to the respective prior execution has resolved a corresponding execution failure.

In an aspect, the current configuration repair set includes at least one of a shell script, a package-manager command, or an edit to a configuration file.

In an aspect, the method further includes: parsing the software code to identify a dependency statement including at least one of an import statement, an include directive, or a package reference; based on the dependency statement, determining a software library used for the execution of the software code; and prior to the execution of the software code, installing the software library in the computing environment.

In an aspect, the method further includes: generating a test program including the identified dependency statement; executing the test program in the computing environment prior to the execution of the software code; and collecting a test execution log as at least a part of the first execution log.

In an aspect, the method further includes: identifying initial configuration parameters from at least one of the software code or an associated documentation; and configuring the computing environment based on the initial configuration parameters prior to the execution of the software code.

In an aspect, the initial configuration parameters include at least one of a software configuration parameter, a hardware configuration parameter, or a runtime configuration parameter.

In an aspect, the associated documentation includes at least one of a README file, a configuration file, or comments embedded in the software code.

In an aspect, the method further includes: identifying a first runtime parameter for the software code from a documentation associated with the software code; performing a third execution of the software code based on the first runtime parameter to collect a third execution log; using a fifth trained MLM to obtain an inferred parameter based on at least one of the third execution log or a static analysis of the software code; modifying the computing environment based on the inferred parameter; and retaining the inferred parameter when a fourth error-volume metric from a fourth execution log is less than a third error-volume metric from the third execution log.

In an aspect, the static analysis of the software code includes: generating an abstract syntax tree for the software code; from the abstract syntax tree, identifying a code element depending on the first runtime parameter; and using the fifth trained MLM to determine a candidate value for the inferred parameter.

In an aspect, the method further includes: crawling a source code repository to obtain data including at least one of source code, documentation, or issue reports; using a sixth trained MLM to extract configuration information from the obtained data; and storing the configuration information in a knowledge base.

In an aspect, the configuration information includes at least one of a supported library version, a required hardware capability, or a known incompatibility.

In an aspect, the computing environment includes at least one of a virtual machine, a container, or a sandbox.

An aspect of this disclosure provides a system for automated reconfiguration of computing environments. The system includes processing circuitry configured to: execute software code within a computing environment; collect a first execution log generated during the execution of the software code; process the first execution log with a first trained MLM to identify configuration-related failures in the computing environment; query a database storing a plurality of historical execution logs associated with prior executions and corresponding configuration repair sets to select a historical log having a statistical similarity to the first execution log using a second trained MLM; generate a current configuration repair set for the computing environment using a third trained MLM configured to adapt a configuration repair set corresponding to the selected historical log to a current environment state of the computing environment; and automatically reconfigure the computing environment by applying the current configuration repair set to resolve the identified configuration-related failures.

An aspect of this disclosure provides a non-transitory computer-readable medium storing thereon computer-executable instructions for automated reconfiguration of computing environments, including instructions for: executing software code within a computing environment; collecting a first execution log generated during the execution of the software code; processing the first execution log with a first trained MLM to identify configuration-related failures in the computing environment; querying a database storing a plurality of historical execution logs associated with prior executions and corresponding configuration repair sets to select a historical log having a statistical similarity to the first execution log using a second trained MLM; generating a current configuration repair set for the computing environment using a third trained MLM configured to adapt a configuration repair set corresponding to the selected historical log to a current environment state of the computing environment; and automatically reconfiguring the computing environment by applying the current configuration repair set to resolve the identified configuration-related failures.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 shows a block diagram illustrating a system for implementing an artificial intelligence (AI) assistance infrastructure configuration engine according to some aspects of this disclosure.

FIG. 2 shows a block diagram illustrating a system for training machine learning models to identify configuration parameters for execution of the software code according to some aspects of this disclosure.

FIG. 3 shows a first flow diagram of a method for machine learning (ML)-based analysis of scientific or technical documents and associated software code according to some aspects of this disclosure.

FIG. 4 shows a second flow diagram of a method for machine learning (ML)-based analysis of scientific or technical documents and associated software code according to some aspects of this disclosure.

FIG. 5 shows a flow diagram of a method for executing software code associated with scientific or technical documents in a virtual environment according to some aspects of this disclosure.

FIG. 6 shows an example of a method executing software code associated with scientific or technical documents in a virtual environment according to some aspects of this disclosure.

FIG. 7 shows a system for implementing an AI-based computing environment configuration engine according to some aspects of this disclosure.

FIG. 8 shows an example of a historical configuration database according to some aspects of this disclosure.

FIG. 9 shows a process for automated configuration and repair of computing environments according to some aspects of this disclosure.

FIG. 10 shows another process for automated configuration and repair of computing environments according to some aspects of this disclosure.

FIG. 11 shows a process for construction of a knowledge database according to some aspects of this disclosure.

FIG. 12 shows a flowchart illustrating a method for automated configuration and repair of computing environments according to some aspects of this disclosure.

FIG. 13 shows an example of a general-purpose computer system on which aspects of the present disclosure can be implemented.

Like reference numbers and designations in the various drawings indicate like elements.

### DETAILED DESCRIPTION

Exemplary aspects are described herein in the context of a system, method, and computer program product for machine learning (ML)-based execution of software code from scientific or technical documents in a secure computing environment. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The present disclosure describes various aspects of machine learning (ML) based execution of software code from scientific or technical documents in a secure virtual environment. One aspect involves using ML to analyze a scientific or technical document to identify hardware, software, and/or runtime configuration parameters for execution of software code associated with the scientific or technical document. A second aspect involves using ML to identify configuration parameters of the virtual environment associated with a cause of failure in execution of the software code. A third aspect involves using ML to compare the documents and/or software code with previously analyzed documents and/or software codes to identify a similar document and/or software code in the database and the associated known configuration parameters.

A scientific or technical document may have software code associated with it for several reasons, depending on the nature of the research and its field. A fundamental principle of scientific research is reproducibility, which requires that other researchers can replicate the results presented in a study. Sharing computer code fosters transparency, allowing others to verify the findings or expand upon the research. In many scientific and engineering disciplines, researchers may use complex models and simulations that are developed as part of the study. Providing the software code also ensures that other researchers can run these simulations under similar conditions to understand the models better, validate the results, or test them against different datasets. In addition, many scientific or technical documents may involve the analysis of large datasets. Computer code may be provided to show how data was processed, analyzed, or visualized. Furthermore, code associated with scientific or technical documents provides a reference for how the authors implemented a particular algorithm or method. This is particularly important in cases where the method’s details may be too complex to describe fully in text, or where small differences in implementation might significantly affect the results. It should be noted that the invention is not limited to scientific or technical documents, but includes any type of research paper, or the like.

However, validating software code associated with scientific or technical documents in virtual environments presents a number of challenges.

First, the manual setup of identifying hardware, software, and/or runtime configuration parameters for the execution of the software code in a virtual environment is time-consuming and prone to user errors, especially when researchers (who may not have a technical background or experience in computer programming) need to identify and configure the configuration parameters. Automation streamlines this process, allowing researchers to focus on the core scientific tasks instead of setting up and configuring the computing environment. By automating the setup and implementation of virtual environments, researchers may easily and reliably recreate computing environments. In this way, collaboration and sharing of results may be accelerated, ensuring that the research described in the scientific or technical documents can be easily replicated by others.

Second, automation guarantees that the same environment is set up consistently, reducing variability between experimental runs due to mismatched software versions or configuration errors. Automated setup systems can ensure that all experiments adhere to certain standards or protocols, increasing the scientific rigor of the research. Software code may be written in a specific environment (e.g., specific operating systems, libraries, or versions of dependencies), and without detailed documentation. Variations in hardware, software, and/or runtime configurations may lead to inconsistent results.

Third, leveraging AI to select and configure the necessary tools ensures that only the essential resources are deployed, optimizing computational resources and reducing waste. For example, AI can determine the best cloud instances, hardware accelerators (GPUs or TPUs) or storage solutions for specific tasks. AI may dynamically adjust the configuration parameters based on project requirements or ongoing experimental needs, improving the efficiency of high-performing computing environments.

Fourth, modern research, particularly in fields like genomics, astrophysics, and AI, often involves large-scale datasets and complex computational workflows. AI-driven automation can streamline and orchestrate these workflows, ensuring that all dependencies are met and the correct parameters are applied to each stage of the analysis. As machine learning and AI become central to many fields, automated setups can ensure that most optimal configuration parameters are correctly configured, reducing the burden on researchers unfamiliar with these tools.

Automating the setup of configuration parameters for execution of the software code, especially when combined with AI for configuration parameter selection, management, and troubleshooting, enables faster, more reliable research. In addition, the present disclosure optimizes resource usage, facilitates collaboration, and ensures that the experiments are conducted in well-tuned, error-free environments. This kind of automation is increasingly essential in modern scientific inquiry, where complexity, data, and computational demands continue to grow exponentially.

It should be noted that the present disclosure describes utilizing a computing environment for analyzing research projects based on scientific articles for illustrative purposes only and that the methods and systems described in the present disclosure may be applicable to any activity that involves comparing logic, parameters, and/or algorithms between an academic paper and computer code. As a non-limiting example, the methods and systems described in the present disclosure may be applicable to business papers and computer code.

Accordingly, the present disclosure describes a ML-based approach for analyzing documents and software code to identify hardware, software, and runtime configuration parameters necessary for executing the software. By automating the extraction of these configuration parameters, the present disclosure reduces the need for manual identification, thereby improving accuracy, efficiency, and consistency. In this way, the present disclosure enables faster setup and replication of execution environments while minimizing human errors. Additionally, this approach may enhance software deployment by identifying potential compatibility issues early in the development lifecycle and ensuring the correct execution environment. This approach ultimately streamlines software execution, optimizes deployment, and enhances overall system reliability.

In addition, the present disclosure also describes an ML-based approach for analyzing the execution log using a second prepared machine learning model (MLM) to identify configuration parameters of the virtual environment associated with a cause of failure in execution of the software code. The present disclosure enhances failure analysis by automating the detection of misconfigurations, compatibility issues, and resource constraints that may lead to execution errors. By leveraging ML to analyze execution logs, the approach also reduces the need for manual debugging, improving efficiency and accuracy in diagnosing failures. In this way, rapid root cause identification, minimizing downtime and accelerating issue resolution may be enabled. It is particularly beneficial in complex or dynamic environments where virtual configurations frequently change, making traditional troubleshooting methods inefficient.

Turning now to the figures, example aspects are depicted with reference to one or more components described herein, where components in dashed lines may be optional.

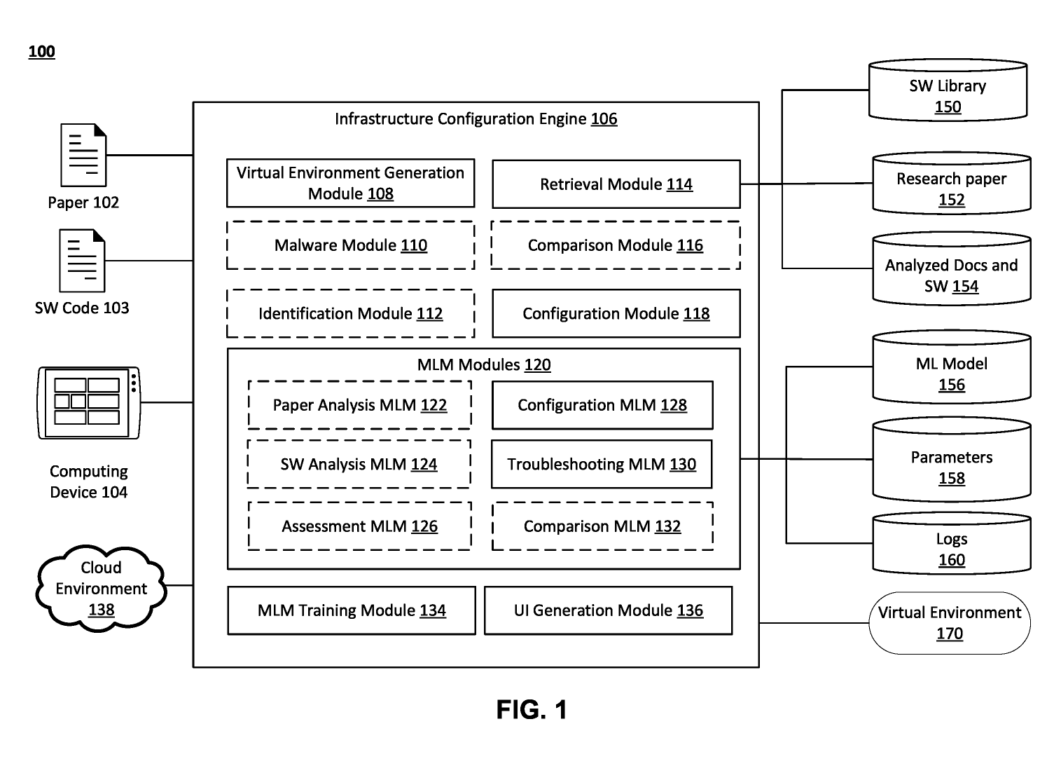

FIG. 1 is a block diagram illustrating a system 100 for implementing an artificial intelligence (AI) assistance infrastructure configuration engine according to aspects of the present disclosure. The system 100 may include a computing device 104, a scientific or technical document 102, software code 103 associated with the document, and an infrastructure configuration engine 106, which may be a software installed on or accessed (e.g., via a virtual machine, container, web application) on the computing device 104. The computing device 104 allows a user to control and configure the system 100 and view a user interface (UI). Computing device 104 may execute a plurality of modules in the infrastructure configuration engine 106 that together make up a retrieval, recognition, configuration, and troubleshooting system. In some aspects, the infrastructure configuration engine 106 may correspond to a computing device 104 that is configured to execute a plurality of modules that together make up the infrastructure configuration engine 106.

Sharing software code in scientific or technical documents is a way to promote transparency, reproducibility, and collaboration, making it easier for the scientific community to validate, extend, or apply the research. It's particularly common in disciplines involving computational methods, data analysis, and software development. The infrastructure configuration engine 106 may be configured to execute a suitable computational environment with configuration parameters to execute software code 103 associated with a scientific or technical document 102. In addition, the infrastructure configuration engine 106 may be configured to automatically setup and/or optimize the software, hardware, and/or runtime configurations and parameters for a virtual environment 170. Furthermore, the infrastructure configuration engine 106 may also be configured to install and execute any services needed to execute the corresponding software code 103 to validate the results from the documents 102. If the software code 103 does not execute successfully, the infrastructure configuration engine 106 may further be configured to troubleshoot the failure by analyzing an execution log to identify any configuration parameters that may have caused the failure, modifying the configuration parameters of the virtual environment 170, and then re-executing the software code in the modified virtual environment 170.

For example, the infrastructure configuration engine 106 may obtain at least one scientific or technical document 102 from a research paper database 152 for analysis and identify configuration parameters (e.g., hardware, software, and/or runtime configuration parameters) for execution of the software code 103. The infrastructure configuration engine 106 may then be configured to determine correspondence between parameters in the text of the article and parameters in the attached software code 103 for reconfiguration and analysis. In addition, if the software code 103 fails to execute correctly, the infrastructure configuration engine 106 may then use a ML to analyze an execution log to identify configuration parameters of the virtual environment associated with a cause of failure in execution of the software code 103.

The infrastructure configuration engine 106 may include a virtual environment generation module 108, an optional malware module 110, an optional identification module 112, a retrieval module 114, an optional comparison module 116, a configuration module 118, MLM modules 120 including an optional paper analysis MLM 122, an optional software analysis MLM 124, an optional assessment MLM 126, a configuration MLM 128, a troubleshooting MLM 130, and an optional comparison MLM 132, a MLM training module 134, and a UI generation module 136. The infrastructure configuration engine 106 may be connected to cloud environment 138, a software library database 150, a research paper database 152, an analyzed documents and software database 154, a MLM database 156, a parameters database 158 and/or a logs database 160.

In some aspects, these databases may be hosted in the cloud environment 138. In some aspects, the infrastructure configuration engine 106 (specifically, the UI generation module 136) may generate a UI for display on the computing device 104, which may be part of the client application associated with the infrastructure configuration engine 106. For example, the computing device 104 may be a device belonging to an end user such as a research or learner.

The computing device 104 may execute a UI (not pictured) to obtain, from the user, a scientific or technical document 102 containing at least software code to run the methods, experiments, and/or tests explained in the document 102 and corresponding parameters in the text of the article. For example, if the scientific or technical document 102 corresponds to a chemistry article, the scientific or technical document 102 may include software code 103 to execute computer simulations to validate the method or experiment in the chemistry article. For many users reading the article, they may not understand the software code 103 in the article due to not being computer savvy or the code may be written in a different programing language.

Given the scientific or technical document 102 or a link to the scientific or technical document 102, the MLM modules 120 from the infrastructure configuration engine 106 may generally perform a multi-step process to: (1) understand, compare, and/or validate the results and/or code in the scientific or technical document 102 using trained MLMs (e.g., neural networks, LLMs etc.), (2) understand the logic and parameters of the scientific or technical document 102 and code, (3) dynamically configure the software, hardware, and runtime configurations and configuration parameters for a virtual environment 170, (4) obtain and install needed services for executing the code in the virtual environment 170, (5) troubleshoot the software code by identifying configuration parameters associated with a cause of failure of the software code, and/or (6) modifying the identified configuration parameters and executing the software code in the modified virtual environment 170.

Optionally, the computing device 104 may execute the optional malware module 110 configured to check the software code 103 for malware and/or security vulnerabilities. Malware may be defined as code (whether it is part of a script or embedded in a software system) designed to cause damage, security breaches, or other threats to application security. In addition, based on a determination that the software code 103 contains malware and/or security vulnerabilities, the optional malware module 110 may be configured to terminate execution of the software code 103 to protect the system from the malware code. Malware code may cause major disruption to the computer and network since hackers can use the malware code to gain control of computers and passwords may be compromised.

In some aspects, the computing device 104 may execute the optional identification module 112 configured to identify subject matter, logic, algorithms, and/or parameters from the scientific or technical document 102. In some aspects, the computing device 104 may execute the optional identification module 112 configured to identify subject matter, logic, algorithms, and/or configuration parameters represented in portions of the software code 103 based on the obtained description of the subject matter, logic, algorithms, and/or configurations parameters from external sources.

In addition, the identification module 112 may be configured to identify and load into the virtual environment 170 one or more software libraries necessary for execution of the software code 103. This ensures a smooth execution of software code 103 within the virtual environment 170 by identifying and loading the necessary software libraries. This functionality involves analyzing the code's dependencies, determining the required libraries, and obtaining them for integration into the virtual environment 170. By automating this process, the system 100 eliminates the need for manual intervention, reduces setup time, and ensures compatibility between the code 103 and its dependencies. This capability is particularly significant in complex or dynamic environments, where maintaining consistency and reducing errors are critical for efficient execution and testing.

In some aspects, the computing device 104 may execute a retrieval module 114 configured to retrieve a scientific or technical document 102 and a software code 103 associated with the scientific or technical document. The software code 103 may include executable code and/or source code. In some aspects, the retrieval module 114 may access the software library database 150, the research paper database 152, and/or the analyzed documents and software database 154. In some aspects, the retrieval module 114 may obtain a description of the subject matter, logic, algorithms, and/or parameters from external sources. In some aspects, the retrieval module 114 may access the scientific or technical documents 102 and the associated software code 103 from the internet or any other suitable sources.

In some aspects, the computing device 104 may execute the optional comparison module 116 configured to identify corresponding algorithms and parameters in the scientific or technical document 102 and the software code 103. Specifically, the optional comparison module 116 may compare subject matter, logic, algorithms, and/or parameters of the scientific or technical document 102 with the subject matter, logic, algorithms, and/or parameters of the associated software code 103 to identify corresponding subject matter, logic, algorithms, and/or parameters between the scientific or technical document 102 and the software code 103.

In some aspects, the computing device 104 may execute a configuration module 118 to configure the virtual environment 170 based at least in part on identified configuration parameters. In addition, the configuration module 118 may adjust configuration parameters or values of the configuration parameters in the software code 103 and/or configure the virtual environment 170 based at least in part on identified configuration parameters. Furthermore, the configuration module 118 may generate prompts based on the configuration parameters of the code and create a script for changing parameters of the software code and/or virtual environment 170 either due to experimentation, troubleshooting, or software code failure. After the configuration parameters or values of the parameters are adjusted, the software code 103 and/or virtual environment 170 may be re-executed with the updated configuration parameters and the results are re-analyzed.

In some aspects, the computing device 104 may execute a MLM module 120 including an optional paper analysis MLM 122, an optional software analysis MLM 124, an optional assessment MLM 126, a configuration MLM 128, a troubleshooting MLM 130, and/or an optional comparison MLM 132. The optional prepared paper analysis MLM 122 is configured to identify subject matter, algorithms, parameters, and/or logic of the scientific or technical document 102 using a text interpretation LLM. The optional prepared SW analysis MLM 124 is configured to analyze software code associated with the scientific or technical document to also identify subject matter, algorithms, parameters, and/or logic of the software code using software code from a software library database 150. The optional prepared assessment MLM 126 may be configured to assess whether the software code 103 corresponds to the scientific or technical document 102 and generates text explaining the results of the comparison using a text generation LLM. The configuration MLM 128 may be configured to identify hardware, software, and/or runtime configuration parameters for execution of the software code 103 by analyzing the document 102 and software code 103. The troubleshooting MLM 130 may be configured to identify configuration parameters of the virtual environment 170 associated with a cause of failure in execution of the software code 103 based on an execution log. The optional comparison MLM 132 may be configured to compare the document 102 and/or software code 103 with previously analyzed documents and/or software code from the analyzed documents and software database 154 to identify a similar document and/or software code in the software library database 150 and the associated known configuration parameters

In some aspects, the optional paper analysis MLM 122, the optional software analysis MLM 124, the optional assessment MLM 126, the configuration MLM 128, the troubleshooting MLM 130, and/or the optional comparison MLM 132 may contain specifically trained MLMs. For illustrative purposes, the present disclosure will describe the MLM as an LLM, but those of ordinary skill in the industry will recognize that any suitable type of MLM may be utilized in the present disclosure.

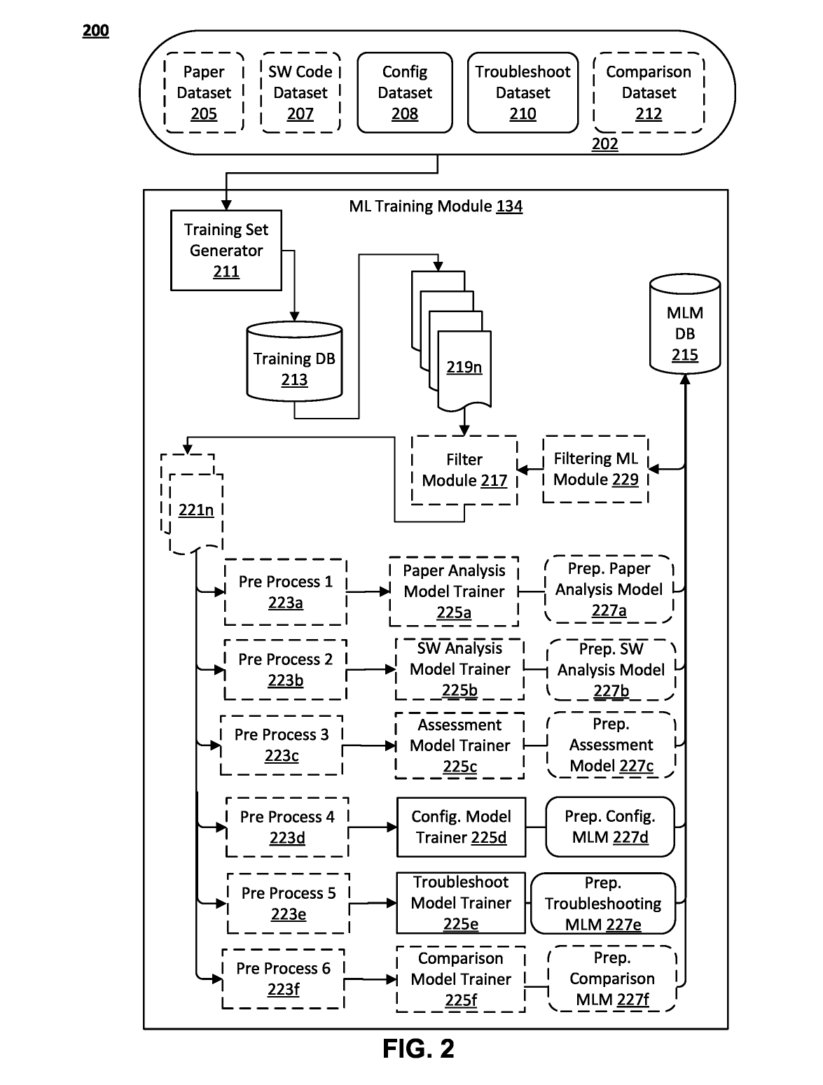

An LLM is a type of AI designed to understand and generate human language. LLMs are trained on vast amounts of text data, enabling them to perform a wide range of language-related tasks such as answering questions, summarizing text, translating languages, or generating content. LLMS, similar to GPT (generative pretrained transformers), use deep learning techniques to recognize patterns, learn context, and predict word sequences making them highly versatile in natural language processing applications. Accordingly, the computing device 104 may execute the MLM training module 134 to train the LLMs in the optional paper analysis MLM 122, the optional software analysis MLM 124, the optional assessment MLM 126, the configuration MLM 128, the troubleshooting MLM 130, and/or the optional comparison MLM 132 to teach the MLMs to perform their respective specific tasks. Further details about the training of each respective MLM will be described in FIG. 2.

A transformer is a deep learning architecture used in large language models (LLMs). The transformer has an encoder/decoder structure with numerous stacked multi-head attention layers and feed forward network layers. This architecture allows the model to process and generate text effectively, capturing long-range dependencies and contextual information. Transformers are well-suited for tasks like natural language processing, and image classification and generation. Common examples of transformer models are generative pre-trained transformers (GPT) and Bidirectional Encoder Representations from Transformers (BERT).

For analysis tasks such as analyzing the document 102 and/or software code 103, an unprepared configuration MLM 128 will first analyze data from a configuration training dataset to “learn” how to identify hardware, software, and/or runtime configuration parameters for execution of the software code. As an example, the configuration training dataset may include at least annotated software document that may include technical manuals, user guides, and other descriptive materials that detail system requirements, dependencies, and runtime configurations. This training dataset may be annotated to highlight references to hardware (e.g., CPU, GPU, memory), software (e.g., required libraries, frameworks, and versions), and runtime parameters (e.g., environment variables, configuration options). The configuration training dataset may also include annotated source code that involves samples of code in various programming languages, with annotations identifying elements such as important statements, hardware-specific API calls, and configuration file references. These structures explicitly list the dependencies, runtime setups, and hardware requirements necessary for software execution. In addition, the configuration training dataset may also include log files generated during software execution providing valuable insights into runtime conditions. These files may contain messages about hardware utilization (e.g., GPU memory), software issues (e.g., missing dependencies), and runtime errors (e.g., “out of memory” or “library version mismatch). The annotated logs enable the configuration MLM 128 to recognize patterns indicating configuration requirements. Furthermore, the configuration training dataset may include a diverse range of benchmarks and compatibility matrices that document the relationship between various hardware, software, and runtime configurations and their performance. This helps the configuration MLM 128 generalize across different environments.

To further enhance the model's capabilities, unlabeled data, such as large corpora of software documentation and code, can be used for pretraining, allowing the configuration MLM 128 to develop a foundational understanding of technical language and context. Preprocessing these data sources, maintaining a consistent labeling schema, and ensuring a diverse range of programming languages and domains are represented will contribute to building a robust and effective MLM.

During training of the configuration MLM 128, the results from the untrained MLM are then compared with known data set results using the corresponding labels identifying different types of configuration parameters and their effectiveness. It should be noted that the input to the trained configuration MLM 128 will be data from the training dataset.

For every input training sample from the training dataset, the trained configuration MLM 128 will produce a prediction consisting of values representing a probability that a particular hardware, software, and/or runtime configuration parameter is identified. The output with the highest probability determines the identification. A class label for each answer may be used to compute a loss (e.g., loss function).

The trained configuration MLM 128 then uses a loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal. In some examples, an appropriate loss function, such as Mean Squared Error (MSE) for regression tasks or a Cross-Entropy Loss for classification tasks.

Once the MLM is trained, the trained configuration MLM 128 may identify hardware, software, and/or runtime configuration parameters for execution of the software code based on analyzing the document 102 and/or software code 103.

During inference, the trained configuration MLM 128 does not re-evaluate or adjust the layers of the neural network based on the results. Instead, the inference applies knowledge from the trained neural network and uses it to infer a result. Accordingly, when a new unknown dataset (e.g., new software project) is input through the trained configuration MLM 128, the trained MLM outputs a score identifying hardware, software, and/or runtime configuration parameters for execution of the software code based on predictive accuracy of the MLM.

Similarly, during preparation (or training) of the troubleshooting MLM 130, the troubleshooting training dataset will include at least annotated execution logs that capture failures in diverse virtual environments. These execution logs should include records of runtime errors, warnings, and debugging outputs that detail failures such as missing dependencies, incompatible library version, incorrect environment variables, insufficient resources (e.g., memory or GPU availability), or unsupported configurations. Each log entry is also annotated to highlight the root cause of the failure and the associated configuration parameters (e.g., GPU not enabled, or mismatched Python version). In addition, labeled examples of successful and failed executions may also be included in the troubleshooting training database. This type of training data will include details of the environment setup, such as software versions, runtime dependencies, and hardware configurations. For example, the execution logs may indicate the differences in configurations between a successful execution with Python 3.9 and TensorFlow 2.6 and a failed execution with Python 3.6 and TensorFlow 2.3. Another type of troubleshooting training data may include a collection of synthetic or real-world execution logs that illustrate edge cases. For example, this may include errors triggered by insufficient disk space or unexpected interactions between dependencies. Each scenario may be annotated with detailed information about the failing parameter (e.g., memory allocation, dependency conflicts, or runtime environment mismatch).

For every input training sample from the configuration training dataset, the prepared troubleshooting MLM 130 may produce a prediction consisting of values representing a probability that an identified configuration parameter for the virtual environment is associated with a failure cause in the execution of the software code. The output with the highest probability determines the predicted configuration parameters associated with the failure.

Optionally, during training of the optional comparison MLM 132, the comparison training dataset may include pairs of documents or software code with labeled similarity scores or classifications. This data should encompass diverse programming languages, code styles, and documentation formats, annotated with metadata such as dependencies, runtime configurations, and hardware requirements. Additionally, the comparison training dataset should include examples of previously analyzed documents or code with their known configurations, allowing the model to learn associations between code features and configuration parameters. Pretraining on a large corpus of unlabeled code and documentation can further enhance the model's ability to understand structural and semantic similarities.

In some aspects, an optimizer such as Adam or SGD may be used to train the models in the optional paper analysis MLM 122, the optional software analysis MLM 124, the optional assessment MLM 126, the configuration MLM 128, the troubleshooting MLM 130, and/or the optional comparison MLM 132. In some aspects, the data may be split into training, validation, and test sets. In these aspects, the optional paper analysis MLM 122, the optional software analysis MLM 124, the optional assessment MLM 126, the configuration MLM 128, the troubleshooting MLM 130, and/or the optional comparison MLM 132 are trained on the training dataset and then validated by the validation sets in order to tune hyperparameters.

The computing device 104 may execute a UI generation module 136 configured to receive inputs from a user and display, in a UI, the execution log on a UI. This module serves as an interactive bridge between the user and the system 100, allowing users to efficiently access and analyze execution logs in a structured and visually comprehensible manner. By enabling real-time log visualization, it enhances debugging and troubleshooting by providing clear insights into execution events, errors, and configuration parameters. The UI generation module 136 also allows users to filter, search, and navigate logs dynamically, improving efficiency in identifying issues and optimizing software performance. This functionality is particularly valuable in complex software environments where manual log inspection can be time-consuming and error prone. Furthermore, by integrating interactive UI elements, such as charts, highlighting, and categorization, the module improves user experience and accelerates root cause analysis. Overall, the UI generation module 136 plays a crucial role in streamlining execution monitoring, enhancing system transparency, and supporting more effective software maintenance and troubleshooting.

It should be noted that the identification of hardware, software, and/or runtime configuration parameters for execution of the software code and the identification of the configuration parameters associated with a cause of failure in execution of the software code is heavily simplified. One of ordinary skill in the art will appreciate that the machine learning models utilized may have significantly large datasets with highly specific details. For example, there may be hundreds of configuration parameters in each execution of the software code. The analysis would be beyond the capabilities of the human mind because the amount of data to be identified and analyzed in each scientific or technical document is unfathomable.

FIG. 2 is a block diagram illustrating a system for training machine learning models to identify logic, algorithms, and/or parameters of scientific or technical documents and associated software code.

As shown in example 200, a MLM training module 134 is configured to build and train specialized machine learning models with inference to perform particular tasks. In this way, the specialized MLMs may develop an ability to perform particular objectives within new data that is not part of a training dataset. By subjecting the specialized MLMs to large amounts of unlabeled and/or labeled trained data sets, the specialized MLMs may perform particular tasks such as identifying hardware, software, and/or runtime configuration parameters for execution of the software code by analyzing the document and/or software code and identifying configuration parameters of the virtual environment associated with a cause of failure in the execution of the software code.

Supervised learning is effective for tasks such as classification (assigning inputs to predefined categories) and regression (predicting continuous values) since it relies on the availability of labeled data for both training and evaluation phases. In supervised learning, the MLM training module 134 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment.

In the training phase, the MLM training module 134 provides the algorithm with a training dataset 202 including input-output pairs. The algorithm learns the mapping function that relates inputs to outputs through an iterative process, adjusting its internal parameters based on the provided examples. During model building, the algorithm creates a model that can generalize from the training data to make predictions on new, unseen data. The model's complexity varies based on the algorithm used. For example, the model may be a simple linear regression model or a complex neural network. During the prediction phase, the MLM training module 134 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, machine refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

In some aspects, the MLM training module 134 contains at least a training database 213 configured to store the raw training data 219n and corresponding labels, a machine learning model database 215 to store the trained models (e.g., the optional paper analysis model 227a, the optional software analysis model 227b, the optional assessment model 227c, the configuration MLM 227d, the troubleshoot MLM 227e, and/or the optional comparison MLM 227f). In some aspects, the MLM training module 134 may contain an optional filtering machine learning module 229 and an optional filter module 217 configured to filter data from the training database 213 for training by removing bad training data.

Training data 202 from the optional research paper dataset 205, the optional software code dataset 207, configuration dataset 208, troubleshoot dataset 210, and/or the optional comparison dataset 212 is received into the MLM training module 134 via the training set generator 211.

An optional filter module 217 is configured to filter out bad training data in order to clean up the training data in the training dataset 219n. In some examples, the optional filter module 217 may be a neural network. In some examples, the optional filter module 217 is a simple mathematical model. In some examples, the cleaned training dataset 221n then undergoes optional preprocessing steps depending on which neural network or model is being trained

The optional preprocess 1 223a, preprocess 2 223b, preprocess 3 223c, preprocess 4 223d, preprocess 5 223e, and/or the preprocess 6 223f are automated processes that modify the raw data received from 219n (or cleaned training dataset 221n) and prepare the raw data as input to the respective model trainers (e.g., an optional paper analysis model trainer 225a, an optional software analysis model trainer 225b, an optional assessment model trainer 225c, a configuration model trainer 225d, a troubleshoot model trainer 225e, and/or an optional comparison model trainer 225f). These may be described in the MLM training module 134 as snippets of code that prepares the datasets. In some examples, the preprocessing module (e.g., preprocess 1 223a, preprocess 2 223b, preprocess 3 223c, preprocess 4 223d, preprocess 5 223e, or preprocess 6 223f) for a particular trainer may be an automated script or code that will be setup the first time any model is trained

The optional paper analysis model trainer 225a, the optional software analysis model trainer 225b, the optional assessment model trainer 225c, the configuration model trainer 225d, the troubleshoot model trainer 225e, and/or the optional comparison model trainer 225f are the scripts or code that train the model. The optional paper analysis model trainer 225a, the optional software analysis model trainer 225b, the optional assessment model trainer 225c, the configuration model trainer 225d, the troubleshoot model trainer 225e, and/or the optional comparison model trainer 225f may be a script or code that holds the instructions on how a model should be trained (e.g., optimization method, model architecture, dataset division, etc.) and also runs the training. The optional paper analysis model trainer 225a, the optional software analysis model trainer 225b, the optional assessment model trainer 225c, the configuration model trainer 225d, the troubleshoot model trainer 225e, and/or the optional comparison model trainer 225f each take as input the raw or filtered processed training data and train the optional paper analysis model 227a, the optional software analysis model 227b, the optional assessment model 227c, the configuration MLM 227d, the troubleshoot MLM 227e, and/or the optional comparison MLM 227f to achieve their specific objectives, respectively.

In summary, the raw dataset 219n or cleaned dataset 221n may optionally go through different preprocessing steps 223a, 223b, 223c, 223d, 223e, and 223f and then a corresponding optional paper analysis model trainer 225a, optional software analysis model trainer 225b, optional assessment model trainer 225c, configuration model trainer 225d, troubleshoot model trainer 225e, and/or optional comparison model trainer 225f to generate an optional prepared paper analysis model 227a, an optional prepared software analysis model 227b, an optional prepared assessment model 227c, a prepared configuration MLM 227d, a prepared troubleshoot MLM 227e, and/or an optional prepared comparison MLM 227f. In some examples, each of these models may be an LLM or autoencoder.

The LLMs are trained through a multi-step process involving vast amounts of text data and sophisticated machine learning techniques. The training generally occurs in three stages: pre-training, fine-tuning, and scaling. The first step generally includes data collection since LLMs require massive amounts of text data to learn the patterns, structures, and relationships in language. The goal is to expose the model to a wide variety of text forms, genres, and topics to help it generalize well to different contexts. In the pre-training phase, the model is then trained on a large corpus of text in an unsupervised manner, typically using self-supervised learning techniques. The most common training objective is language modeling. The training may be done using a neural network architecture called the transformer, which excels at capturing long-range dependencies in text. Pre-training allows the model to learn grammar, facts about the world, and how language is structured.

Key components during the pre-training phase include: a transformer architecture, an attention mechanism, and tokenization. A transformer architecture may be composed of layers of self-attention mechanisms and feed-forward networks, which enable the model to focus on different parts of the input. Next, attention mechanism allows the model to weigh the importance of different words in the context of others, helping it understand relationships in text better than traditional models. Text is then broken into smaller units (e.g., tokens), like words or subwords, to make it easier for the model to process.

After pre-training, the model undergoes fine-tuning to adapt it to more specific tasks, such as question answering, summarization, or chatbot interaction. Fine-tuning uses smaller, task-specific datasets and often involves supervised learning. The model may be exposed to labeled data where inputs (e.g., questions) are paired with expected outputs (e.g., answers) so it can adjust its internal parameters to better perform on that specific task. During training, the model’s predictions are compared to the correct answers, and the differences (errors) are minimized using a loss function like cross-entropy loss. The model’s parameters are updated via optimization algorithms like stochastic gradient descent (SGD) or its variants (e.g., Adam optimizer) to reduce the loss and improve performance.

Once the LLMs are set up, LLMs may be scaled by using more data such as pre-training on larger datasets to improve generalization. LLMs also use hundreds of billions of parameters, increasing their capacity to capture complex language relationships. Models may also be trained for millions of iterations on powerful distributed hardware (e.g., GPUs, TPUs) to refine their internal representations.

The raw training dataset 219n used for training may contain noise and bad training data from the training database 213. Accordingly, to create a clean and filtered training dataset, the optional filter module 217 is configured to filter out unwanted data points from the raw training dataset 219n by developing smaller, less accurate systems based on patterns and metadata information. For example, an automated system may be created to identify hardware, software, and/or runtime configuration parameters for execution of a software code using a prepared configuration MLM 227d to analyze different scientific or technical documents and/or software code. The resulting training dataset 221n may consist of scientific or technical documents and labels, where each scientific or technical document contains labeled configuration parameters

When a new model (e.g., an optional prepared paper analysis model 227a, an optional prepared software analysis model 227b, an optional prepared assessment model 227c, a configuration MLM 227d, a troubleshoot MLM 227e, and/or an optional prepared comparison MLM 227f) is created, and a new process for filtering and automated labeling is established, it is added to the machine learning model database 215 in the MLM training module 134. This enables the new model to be part of the closed-loop model update process. Optionally, at regular intervals, data which is continuously collected can be filtered, labeled, and used to update old models by an optional filtering machine learning module 229. In some examples, the optional filtering machine learning module 229 is a neural network. In some examples, the optional filtering machine learning module 229 is a simple mathematical model.

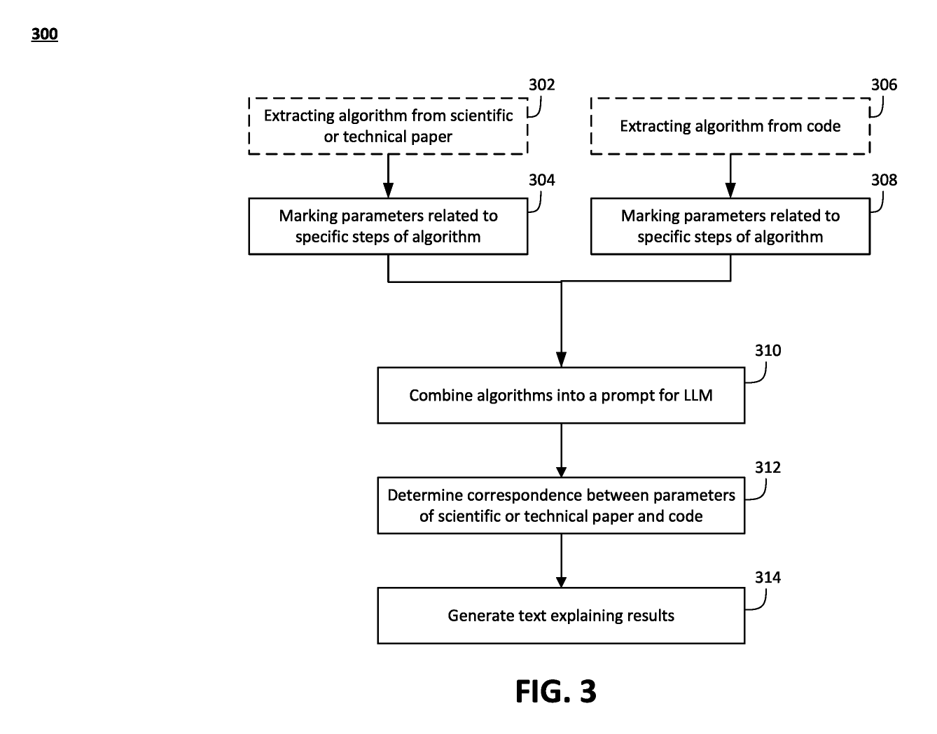

FIG. 3 is a flow diagram of a method for finding correspondence between parameters according to aspects of the present disclosure. In various implementations, the method 300 is performed by a device with one or more processors and non-transitory memory that performs intent prediction. In some implementations, the method 300 is performed by processing logic, including hardware, firmware, software, or a combination thereof. In some implementations, the method 300 is performed by a processor executing code stored in a non-transitory computer-readable medium (e.g., a memory)

Optionally, at 302, the method 300 includes extracting an algorithm (or logic) from a scientific or technical document. Optionally, at 304, the method 300 includes marking parameters related to specific steps of the algorithm. In some aspects, the method 300 includes identifying scientific features such as names of algorithms and parameters from the scientific or technical document and obtaining descriptions of the algorithms and parameters from external sources. In some aspects, the method 300 may include marking parameters from the scientific or technical document, citations in the scientific or technical document, and diagrams in the scientific or technical document.

At 306, the method 300 includes extracting algorithm from software code associated with the scientific or technical document. At 308, the method 300 includes marking parameters related to specific steps of the algorithm

At 310, the method 300 includes combining the algorithms into a prompt for a LLM. In some aspects, this step may include using the LLM to find correspondence between parameters in the scientific or technical document and in the corresponding software code.

At 312, the method 300 includes determining a correspondence between parameters of the scientific or technical document and the software code. This step is necessary because the scientific or technical document may use one set of parameters and values and the software code may use a different set of parameters and values. In this way, the logic of the code may be understood such that each parameter in the scientific or technical document has a mapping to a parameter in the software code.

In some aspects, context may be uploaded for finding correspondence between parameters by a human or via an LLM.

At 314, the method 300 includes generating text explaining results of the correspondence. In this way, a user may understand the logic of the article and code and understand what each parameter means.

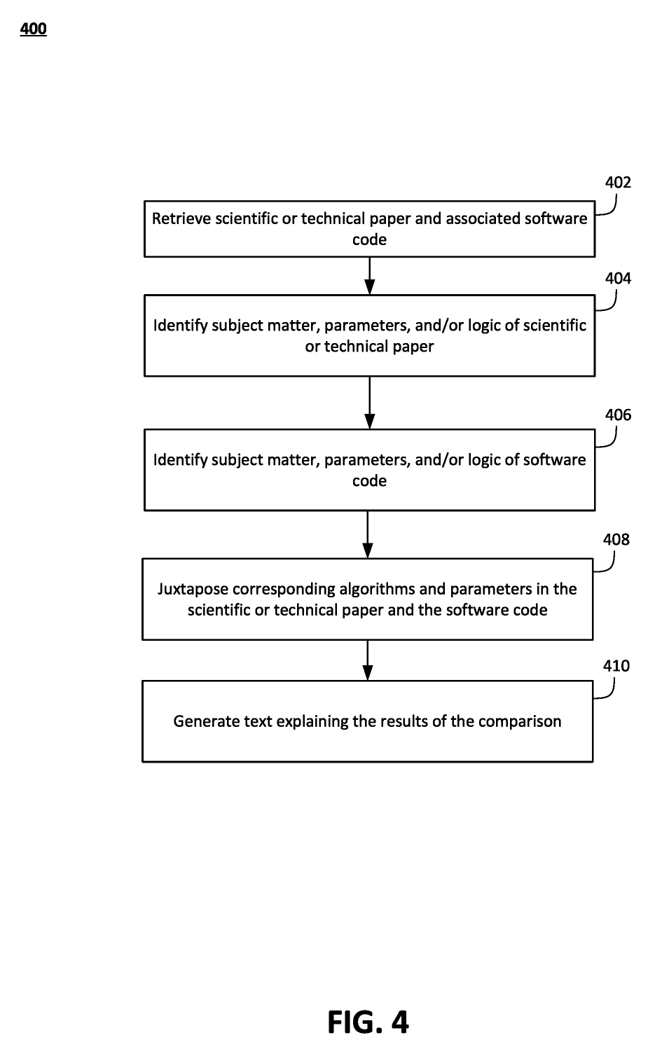

FIG. 4 is a flow diagram of a method for machine learning (ML)-assisted analysis of scientific or technical documents and associated software code according to aspects of the present disclosure. In various implementations, the method 400 is performed by a device with one or more processors and non-transitory memory that performs intent prediction. In some implementations, the method 400 is performed by processing logic, including hardware, firmware, software, or a combination thereof. In some implementations, the method 400 is performed by a processor executing code stored in a non-transitory computer-readable medium (e.g., a memory). The method 400 includes at least analyzing a scientific or technical document and software code associated with the scientific or technical document to create a correspondence between subject matter, logic, algorithms, and/or parameters in the text of the scientific or technical document and parameters in the software code for analysis and/or reconfiguration.

One of the key principles of scientific research is verification and reproducibility, meaning that other researchers should be able to replicate the results described in the scientific or technical document. By providing an accompanying computer code, researchers provide transparency and enable others to verify their findings or build on their work. This is especially important in fields like computational sciences, machine learning, and bioinformatics.

At 402, the method 400 may include retrieving a scientific or technical document and a software code associated with the scientific or technical document. The software code may include executable code and/or source code. In some aspects, the method 400 may include retrieving a link to the software code and running the software code in a dedicated, secure computing environment for analyzing logic and/or parameters of the software code. As an example, referring back to FIG. 1, a retrieval module 114 may be configured to retrieve a scientific or technical document and a software code associated with the scientific or technical document.

In some aspects, the method 400 may include extracting parameters (e.g., dynamic parameters, Courant, Reynolds numbers, etc.) from the scientific or technical document, citations in the scientific or technical document, diagrams in the scientific or technical document, and links to the code repository.

At 404, the method 400 may include identifying scientific features including at least one of subject matter, logic, algorithms, and/or parameters represented in the scientific or technical document by analyzing the scientific or technical document for the scientific features. In some aspects, the scientific features comprise at least data structures, functions and variable of the functions.

Optionally, method 400 may include analyzing the scientific or technical document using a trained paper analysis MLM configured to identify the scientific features represented in the scientific or technical document. In some aspects, the scientific features may include logic, algorithms, and/or parameters of the scientific or technical document that comprise at least data sets, equations and parameters of the equations. As an example, referring back to FIG. 1, a prepared paper analysis MLM 122 may be configured to identify scientific features including at least one of subject matter, algorithms, parameters, and/or logic of the scientific or technical document 102 using a text interpretation LLM.

In some aspects, the method 400 may include preparing the paper analysis MLM based on a text interpretation large language model to identify different subject matter, logic, algorithms, and/or parameters using one or more other scientific or technical documents from a research paper database. This may involve leveraging techniques from natural language processing (NLP), program analysis, and machine learning. Once the paper analysis MLM is sufficiently trained and validated, the paper analysis MLM may be deployed as a service (API) or integrated into a larger code analysis tool or development environment.

In some aspects, the method 400 may include preparing the software analysis MLM to identify different subjects, parameters, and/or logic using one or more software code from a code database.

In some aspects, identifying the corresponding scientific features represented in the analyzed software code is based at least in part on searching for scientific features in the software code using the trained software analysis MLM.

In some aspects, searching for the scientific features in the software code further comprises: obtaining partial algorithms in the scientific or technical document and the software code; identifying scientific features in the partial algorithms in the software code that are similar to the identified scientific features of the partial algorithms in the scientific or technical document; juxtaposing the scientific features found in the partial algorithms in the scientific or technical document and in the partial algorithms in the software code; and determining similarities between the scientific features found in the partial algorithms in the scientific or technical document and partial algorithms in the software code.

In some aspects, searching for scientific features in the software code further comprises: benchmarking the results of the search and displaying a level of confidence corresponding to a similarity of each identified methodology feature represented in the software code with the identified methodology feature represented in the scientific or technical document.

Optionally, in some aspects, the method 400 may include identifying corresponding parameters in the scientific or technical document and the software code by juxtaposing the scientific features of the scientific or technical document with the features of algorithms and parameters of the associated software code; and displaying, in the user interface, at least the identified corresponding parameters in the scientific or technical document and the software code.

At 406, the method 400 may include obtaining a description of the identified scientific features from external sources. In some aspects, the method 400 may include displaying the description of the scientific features to the user for confirmation.

Optionally, the method 400 may include analyzing portions of the software code using a trained software analysis MLM configured to identify scientific features from the scientific or technical document in the software code using a trained software analysis MLM configured to identify the corresponding scientific features represented in the analyzed software code based on the obtained description of the identified scientific features represented in the scientific or technical document. The portions of the software code being identified based on external sources. As an example, referring back to FIG. 1, an optional prepared software analysis MLM 124 may be configured to analyze software code associated with the scientific or technical document to also identify subject matter, algorithms, parameters, and/or logic of the software code using software code from a software library database 150.

As an example, if a methodology feature such as Reynolds number is identified in the article and then a comment in the corresponding software code indicating a “Reynolds number” alongside a variable named “RNDN”, then the optional software analysis MLM 124 can infer that the RNDN variable pertains to the Reynolds number. Alternatively, if a variable itself is named “ReynoldN”, then the optional software analysis MLM 124 may correctly predict that the variable “ReynoldN” relates to the Reynolds number.

In some aspects, the method 400 may include training the software analysis MLM to identify different subject matter, logic, algorithms, and/or parameters using one or more software code from a code database. To analyze software code using the optional prepared software analysis MLM 124, the software code may be preprocessed, run inference with the trained software analysis MLM, and interpret the output including at least identification of subject matter, logic patterns, specific algorithms and/or parameters used in the software code. By interpreting and visualizing the trained software analysis MLM’s output, the method 400 may generate detailed insights into the code structure and functionality.

In some aspects, analyzing the software code may include: generating a secure virtual environment configured to execute software code; and executing the software code in the secure virtual environment. In some aspects, the security virtual environment may include one of a virtual machine, a container, or a sandbox. As an example, referring back to FIG. 1, a virtual environment generation module 108 may be configured to generate and execute a suitable and secure computing environment configured to execute software code (e.g., C++, Python, MATLAB, etc.) attached to a scientific or technical document.

Generating and executing software code in a secure virtual environment offers a wide range of benefits, including improved security, isolation, and reproducibility, as well as efficient resource management. These environments help protect the host system from potential risks, streamline dependency management, facilitate testing and debugging, and enhance portability across platforms. For developers, testers, and system administrators, virtual environments provide a safe and consistent way to execute code, ensuring that software runs reliably in various configurations while minimizing risk to the host system.

In some aspects, executing the software code may include: retrieving and utilizing one or more software libraries for the execution of the software code. The software libraries help execute, manage, and even secure code, offering environments for testing, development, deployment, or scripting. These software libraries and frameworks provide various methods for executing code across multiple domains, whether for testing, development, high-performance computing, or large-scale data processing. The appropriate tool may be selected depending on requirements (e.g., secure execution, distributed processing, or containerized environments) to ensure efficient and secure code execution.

In some aspects, executing the software code may include: checking the software code for malware and/or security vulnerabilities; and based on a determination that the software code contains malware and/or serious security vulnerabilities, terminating execution of the software code. As an example, referring back to FIG. 1, an optional malware module 110 may be configured to check the software code for malware and/or security vulnerabilities, and, based on a determination that the software code contains malware and/or security vulnerabilities, the optional malware module 110 may be configured to terminate execution of the software code to protect the system from the malware code.

In some aspects, the method 400 may further include uploading context for configuring the secure virtual environment and/or finding correspondence between parameters by an agent (e.g., human or LLM). This may include at least: finding the project on a code repository (e.g., GitHub), recognizing the programming language of the project, defining parameters for the code, environment, and requirements, recognizing the programming language of the project, searching for descriptions of libraries, gathering additional information from similar projects, handling voice input to check the sufficiency of requirements and parameters; and using the LLM to ask users additional questions about other requirements and parameters.

In some aspects, an LLM may be used to generate a script for creating a computational/virtual environment (VM) based on the combined requirements and context with suitable parameters of the instance (e.g., GPU, CPU, ARM, memory, disk, versions, or other requirements). The computational/VM is a software environment that allows users to run and test code or simulations in an isolated, controlled space, separate from the main system environment. This isolation helps in managing dependencies, libraries, and settings specific to a project or task without affecting or conflicting with other environments on the system. Next, an instance (e.g., container) may be generated for processing the code based on the parameters. Containers are lightweight environments that package code, libraries, and dependencies together.

At 408, the method 400 may include juxtaposing subject matter, logic, algorithms, and/or parameters of the scientific or technical document with the subject matter, logic, algorithms, and/or parameters of the associated software code to identifying corresponding subject matter, logic, algorithms, and/or parameters in the scientific or technical document and the software code. As an example, referring back to FIG. 1, the optional comparison module 116 may be configured to identify corresponding algorithms and parameters in the scientific or technical document and the software code by comparing subject matter, logic, algorithms, and/or parameters of the scientific or technical document with the subject matter, logic, algorithms, and/or parameters of the associated software code in order to identify corresponding subject matter, logic, algorithms, and/or parameters between the scientific or technical document and the software code.

In some aspects, identifying the correspondence between the software code and the scientific or technical document further comprising: preparing and executing an assessment MLM to perform the assessment of whether the software code corresponds to the scientific or technical document, based on a training dataset comprising scientific or technical documents and corresponding software code, and to generate text explaining the results of the comparison using a text generation LLM. As an example, referring back to FIG. 1, an optional trained assessment MLM 126 may be configured to perform the assessment of whether the software code corresponds to the scientific or technical document 102 and generates text explaining the results of the comparison using a text generation LLM.

In some aspects, assessing whether the software code corresponds to the scientific or technical document further comprises: extracting scientific features from the scientific or technical documents and corresponding software code; marking parameters from the scientific or technical documents related to specific steps of the extracted features; combining the algorithms from the scientific or technical documents and the algorithms from the corresponding software code into prompts for the trained assessment MLM; and determining correspondences between the extracted parameters and corresponding values from text of the scientific or technical documents and parameters and corresponding values from the corresponding software code using the trained assessment MLM.

At 410, the method 400 may include displaying, in a user interface, at least the corresponding scientific features from the scientific or technical document and the software code. In this way, a user may confirm or correct the identified parameters between the scientific or technical document and the software code. As an example, referring back to FIG. 1, UI generation module 136 configured to receive inputs from a user and display, in a UI, corresponding algorithms and parameters in the scientific or technical document and the software code.

In some aspects, the method 400 may include displaying, in the user interface, parameters in the software code using a visual indicator configured to accept, deny, or edit correspondence. This allows a user to easily view and find where particular parameters are presented in the software code.

In some aspects, the method 400 may further include: obtaining a modification of at least one parameter in the software code; and executing the software code with the modified at least one parameter. In this way, a user may find and correct an incorrect parameter in the software code and re-execute the computer code with the modified parameter. A user may modify a parameter by using language commands, configuration files, or any suitable means.

In some aspects, the method 400 may include allowing a user to change parameters in the software code. As an example, the user may modify the variables and observe the impact on the calculation results. As another example, a Reynolds number may be found in the software code and the user can change the value of the Reynolds number within the UI to re-execute the code with a different parameter. A user may want to change the Reynolds number in the software code and re-execute the code for a variety of reasons, particularly related to exploring fluid dynamics, validating results, or studying new scenarios. As an example, the user may want to explore fluid behavior at different flow regimes and since the Reynolds number is a critical parameter in determining whether the flow is laminar, turbulent, or in transition - changing it allows the user to study how fluid behavior evolves across these regimes. Users might want to investigate Reynolds numbers beyond those analyzed in the paper to explore new flow conditions or phenomena. As another example, the user may want to determine the impact of the Reynolds number such that by changing the Reynolds number, the user can study how sensitive a system’s behavior (e.g., drag, heat transfer, or mixing) is to changes in flow characteristics. As yet another example, a user may want to validate computational or theorical results against experimental data that involves different Reynolds numbers. Users may also need to reproduce the findings of a scientific paper by running simulations at the same or similar Reynolds numbers used in the study.

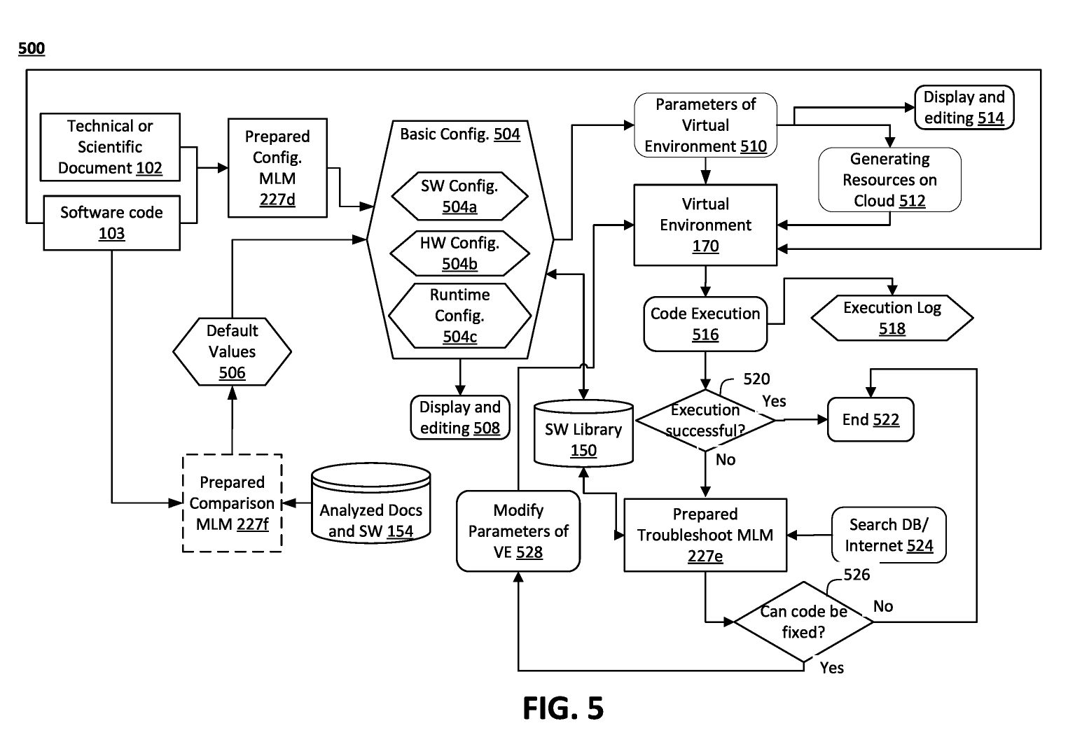

FIG. 5 is aflow diagram of a method 500 for executing software code associated with scientific or technical documents in a virtual environment according to aspects of the present disclosure. In various implementations, the method 500 is performed by a device with one or more processors and non-transitory memory that performs intent prediction. In some implementations, the method 500 is performed by processing logic, including hardware, firmware, software, or a combination thereof. In some implementations, the method 500 is performed by a processor executing code stored in a non-transitory computer-readable medium (e.g., a memory). The method 500 includes at least analyzing a scientific or technical document 102 and software code 103 associated with the document 102 to identify hardware, software, and/or runtime configuration parameters for execution of the software code.

As shown in FIG. 5, the method 500 begins utilizing a prepared configuration MLM 227d (e.g., configuration MLM 128 shown in FIG. 1) to analyze a technical or scientific document 102 and/or software code 103 associated with the document for identifying parameters 510 for the virtual environment 170 including at least hardware configuration parameters 504b, software configuration parameters 504a, and/or runtime configuration parameters 504c for execution of the software code 103 (e.g., collectively, the basic configuration 504). The purpose of the prepared configuration MLM 227d is to identify key execution configuration parameters for execution of the software code in the virtual environment 170. As explained in FIGS. 1-2, the prepared configuration MLM 227d has been prepared (e.g., pre-trained) to recognize patterns within technical documents and source code that indicate essential execution requirements. By analyzing the document 102 and/or the software code 103, the prepared configuration MLM 227d extracts information related to hardware specifications, software dependencies, and runtime configurations, which may also include references to operating systems, required libraries, or specific computational constraints. In addition, the software code 103 is analyzed to detect embedded configuration parameters such as function calls, external dependencies, and environmental variables that may define execution conditions. The prepared configuration MLM 227d then correlates findings from both the documents 102 and/or the software code 103 to determine precise execution requirements, including necessary hardware components (e.g., hardware configuration parameters 504b) like processors or GPUs, software dependencies (e.g., software configuration parameters 504a) such as compilers and frameworks, and runtime settings (e.g., runtime configuration parameters 504c) like execution flags or input parameters.

Basic configurations 504 generally refer to a set of predefined parameters (e.g., at least software configuration parameters 504a, hardware configuration parameters 504b, and/or runtime configuration parameters 504c determined for a particular code) that control the behavior, operation, and performance of the virtual environment 170.

Software configuration parameters 504a define how the virtualized software environment is set up and executed. As a non-limiting example, the software configuration parameters 504a may include at least operating system settings (e.g., Linux kernel version, Windows registry policies), virtual machines (VM) or Container configurations (e.g., Docker Compose YAML, Kubernetes pod specifications), software dependency management (e.g., Python Virtualenv, Conda environments, package versions), networking and security settings (e.g., firewall rules, SSH access, VPN settings), Filesystem and storage mappings (e.g., mounted volumes, cloud storage integration), middleware and application configurations (e.g., web sever settings, API gateways, database connections), languages, packages, links, version control settings (e.g., dependencies, library versions), and the like.

Hardware configuration parameters 504b dictate how the physical resources are allocated and managed in the virtual environment. As a non-limiting example, the hardware configuration parameters 504b may include at least CPU allocation (e.g., number of virtual CPUs assigned, CPU pinning for performance tuning), memory allocation (e.g., RAM limit per VM/container, swap memory usage), storage management (e.g., SSD v. HHD allocation, disk quotas, persistent volume claims in Kubernetes), GPU settings (e.g., GPU pass-through for AI/ML workloads, CUDA-enabled configurations), network configurations (e.g., virtual NIC settings, VLAN configurations, NAT vs. bridged mode), Power Management Policies (e.g., dynamic scaling, auto-shutdown of idle instances), CPU/GPU specifications, memory (e.g., type, size), storage (PVC, type, size), or the like

Runtime configuration parameters 504c influence system behavior during execution. As a non-limiting example, the runtime configuration parameters 504c may include at least one of environmental variables (e.g., PYTHONPATH, JAVA_HOME, LD_LIBRARY_PATH), resource constraints (e.g., CPU and memory limits for containers using cgroups), performance tuning (e.g., garbage collection settings, thread pool sizes), dynamic scaling (e.g., Kubernetes Horizontal Pod Autoscaling (HPA), auto-scaling in cloud environments), session management (e.g., timeout settings, stateful vs. stateless execution), logging and monitoring (e.g., logging levels, distributed tracing with Prometheus, Fluentd, or ELK stack), time executing or permanent executing (e.g., outer servers), a number of exemplars in executing, method of executing (e.g., Terraform, Kubernetes cluster, AVS entities, Docker compose, installation on operation systems), or services (e.g., databases).

The basic configurations 504 for the virtual environment 170 may be stored in the software library database 150 to facilitate efficient provisioning, management, and reuse of configurations for different applications or workloads. By maintaining these parameters in a structured repository, the system ensures consistency across deployments, enabling automated setup of virtual machines and containers without requiring manual reconfiguration. Storing these parameters also allows for version control, ensuring that previous configurations can be referenced, modified, or rolled back if needed. Additionally, the software library database 150 acts as a centralized knowledge base, making it easier to standardize deployments across different environments, troubleshoot, enhance security compliance, and optimize resource allocation based on predefined settings. This approach improves operational efficiency by allowing rapid scaling, seamless updates, and better troubleshooting when deploying software in virtualized or containerized environments.

In some aspects, the basic configurations 504 and/or the identified parameters 510 including at least hardware configuration parameters 504b, software configuration parameters 504a, and/or runtime configuration parameters 504c for execution of the software code 103 may be displayed to a user through a UI 508, 514 or other suitable display mechanism. This presentation allows the user to review and optionally modify any of the displayed basic configurations 504 or displayed parameters 510 of the virtual environment before commencing execution of the software code 103 in the virtual environment 170. By providing users with the opportunity to manually configure or fine-tune these parameters, the system ensures that the chosen hardware, software, and runtime settings align with the specific requirements or preferences for the given execution, thereby enhancing the flexibility and adaptability of the overall environment.

Parameters 510 for the virtual environment are actual configuration settings for the virtual execution environment determined based on basic configuration parameters. The identified parameters 510 for the virtual environment encompass the configuration details and settings required to define how a piece of software or an application will run in a virtual or containerized space. In some aspects, the virtual environment may correspond to a virtual machine and container (e.g., Terraform). These identified parameters 510 may include hardware specifications (e.g., CPU cores, memory allocation, GPU access), software components (e.g., operating system version, application dependencies, libraries), networking configurations (e.g., ports, load balancers, DNS settings), storage requirements (e.g., volumes, file system types), security policies (e.g., access controls, encryption settings), and/or runtime configurations (e.g., environment variables, startup scripts, scaling rules). By identifying and organizing these parameters, the system can accurately provision and manage virtual environments that are tailored to the needs of each application or workload.

As a non-limiting example, the identified parameters 510 of the virtual environment may include at least one of: selecting whether to execute code in a virtual machine (VM) or container, select which type/manufacturer VM or container is better (e.g., Docker), select which cloud provider to use (e.g., MS Azure, Google Cloud or AWS), select virtual CPU/memory/storage requirements for code execution, select Kubernetes or Terraform, or selecting security configuration for the virtual environment (e.g., SSH config). Accordingly, the identified parameters 510 of the virtual environment 170 may be used to create, configure, and deploy resources on a cloud platform 512, such as through Terraform or Kubernetes. For example, by translating these identified parameters into infrastructure-as-code definitions, Terraform can dynamically provision and manage the underlying compute, storage, and networking resources. As another example, Kubernetes may orchestrate and scale containerized applications in accordance with the parameters defined for the virtual environment 170.

In some aspects, prior to analyzing the document 102 and/or software code 103 using the prepared configuration MLM 227d, an optional prepared comparison MLM 227f (e.g., comparison MLM 132 from FIG. 1) may access an analyzed documents and software database 154 containing previously analyzed documents and associated software codes with known hardware, software, and/or runtime configuration parameters to identify a similar document and/or software code in the database and the associated known configuration parameters. In this way, the system may leverage already analyzed documents and associated software codes to pre-configure the virtual environment 170 with default parameter value 506, streamlining setup and reducing the need for manual configuration. This approach enhances efficiency by reusing previously established configurations for similar documents

In the execution stage, once the virtual environment 170 is provisioned with the identified parameters 510, the software code 103 is executed 516 within this configured virtual environment 170. This execution process ensures that the code operates with the appropriate hardware resources, software dependencies, and runtime settings, reducing variability and improving reproducibility across different deployments. As the software runs, an execution log 518 is generated to capture critical details such as system resource usage, runtime events, error messages, and performance metrics. This execution log 518 provides valuable insights into the execution process, aiding in debugging, performance optimization, and compliance tracking. By maintaining a structured execution log 518, the system enables better monitoring, troubleshooting, and auditing of software performance in both development and production environments.

In some aspects, the software code 103 may be executed in a “sandbox” mode.

The execution log 518 can be utilized by Docker containers in conjunction with Ansible, particularly when deploying virtual machines via Terraform. Additionally, the system supports direct deployment of Docker containers using Kubernetes through HELM (E.g., a package manager for Kubernetes that simplifies the deployment and management of applications within Kubernetes clusters). This functionality ensures streamlined automation and orchestration of the virtual environment 170, enhancing deployment efficiency and consistency across different containerized infrastructures.

At 520, the method 500 determines whether code execution is successful. Based on a determination that code execution is successful, then the method 500 ends 522. Based on a determination that the execution is not successful 520, the method 500 continues to a troubleshooting stage.

A prepared troubleshooting MLM 227e (e.g., troubleshooting MLM 130 from FIG. 1) may be prepared to analyze at least the execution log 518 to identify configuration parameters of the virtual environment that may be linked to execution failure. As described in detail in FIGS. 1-2, the prepared troubleshooting MLM 227e is trained on historical execution data from the software library database 150, error patterns, and system behavior to detect anomalies or misconfigurations that could have contributed to the failure. By examining factors such as resource allocation mismatches, dependency conflicts, runtime errors, or performance bottlenecks, the prepared troubleshooting MLM 227e can pinpoint potential root causes efficiently. This automated analysis helps reduce manual debugging efforts, accelerates issue resolution, and improves system reliability by suggesting corrective actions, such as adjusting hardware resources, updating dependencies, or modifying runtime configurations to prevent future failures.

To enhance troubleshooting, the prepared troubleshooting MLM 227e can search internal databases 524 or the software library database 150 for past failures, compare execution logs to known issues, and suggest proven fixes. Additionally, prepared troubleshooting MLM 227e can query online sources, such as technical forums, documentation, and cloud provider recommendations, to identify potential solutions and best practices.

At 526, a determination is made based on the results of the prepared troubleshooting MLM 227e as to whether the software code may be fixed by modifying parameters for the virtual environment. Based on a determination that the code cannot be executed successfully in the virtual environment 170 (e.g., cannot be fixed), the method 500 ends 522. Based on a determination that parameters of the virtual environment may be modified to fix execution (e.g., can be fixed) according to results of the troubleshooting, the method 500 continues to a modification stage.

In the modification stage, the parameters of the virtual environment may be modified 528 according to results from the troubleshooting and the software code 103 is re-executed 516 within the virtual environment 170 provisioned with the modified identified parameters 510. The method 500 then re-continues to the execution stage and troubleshooting stage.

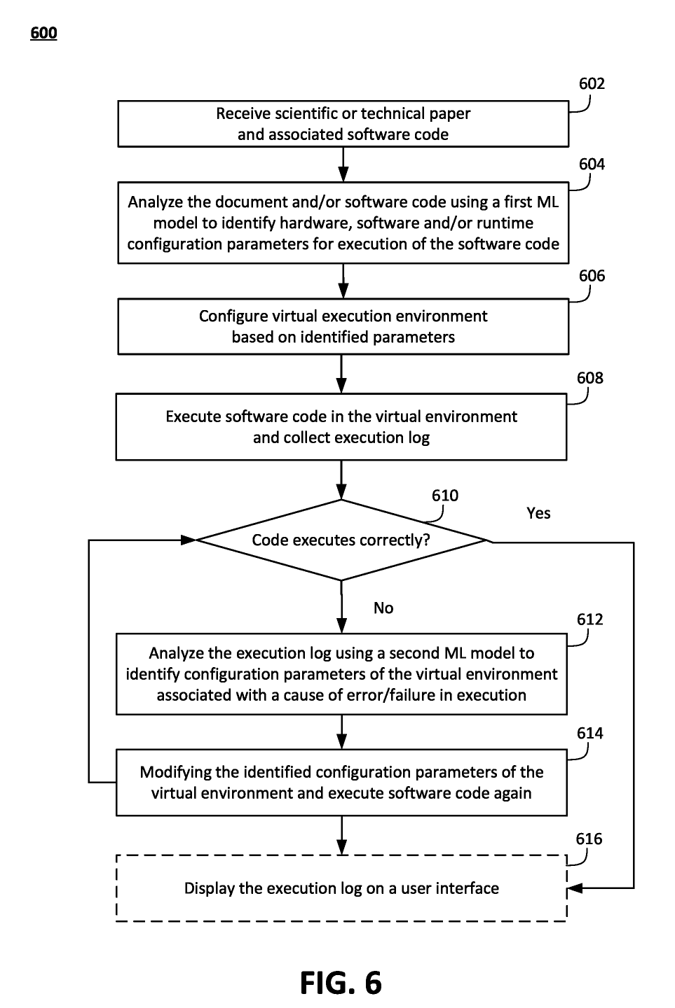

FIG. 6 is an example of a method for executing software code associated with scientific or technical documents in a virtual environment according to aspects of the present disclosure. In various implementations, the method 600 is performed by a device with one or more processors and non-transitory memory that performs intent prediction. In some implementations, the method 600 is performed by processing logic, including hardware, firmware, software, or a combination thereof. In some implementations, the method 600 is performed by a processor executing code stored in a non-transitory computer-readable medium (e.g., a memory). The method 600 includes executing software code associated with scientific or technical documents in a virtual environment.

At 602, the method 600 may include receiving a scientific or technical document and software code associated with the document. The software code may include executable code and/or source code.

At 604, the method 600 may include analyzing the document and/or software code using a first prepared MLM (e.g., the configuration MLM 128 in FIG. 1, and the prepared configuration MLM 227d in FIGS. 2 and 5) to identify hardware, software and/or runtime configuration parameters for execution of the software code.

In some aspects, the first prepared MLM corresponds to a large language model (LLM).

Optionally, in some aspects, the method 600 may include: prior to analyzing the document and/or software code using the first prepared MLM, accessing a database containing a plurality of previously analyzed documents and associated software codes with known hardware, software and/or runtime configuration parameters (e.g., analyzed documents and software database 154 shown in FIGS. 1 and 5); comparing, using a third prepared MLM (e.g., comparison MLM 132 from FIG. 1 or the optional prepared comparison MLM 227f from FIGS. 2 and 5), the document and/or software code with the previously analyzed documents and/or software codes to identify a similar document and/or software code in the database and the associated known configuration parameters; and configuring the virtual environment based at least in part on one or more of the known configuration parameters of the similar software code from the database.

In some aspects, the third MLM corresponds to an autoencoder or a transformer-based model. An autoencoder is a type of neural network used for unsupervised learning, primarily for feature extraction and dimensionality reduction. It consists of an encoder, which compresses input data into a lower-dimensional representation (latent space), and a decoder, which reconstructs the original input from this representation. This framework is utilized for extracting feature embeddings from complex datasets. Conversely, transformer-based models leverage self-attention mechanisms to process input data, capturing complex dependencies and contextual information without the need for compression into a latent space. These models, therefore, generate contextual embeddings that encapsulate both local and global relationships within the data. To implement the third prepared MLM for comparing documents and software code, one could utilize either an autoencoder or a transformer-based approach. These models can be trained on datasets containing previously analyzed documents and software codes to derive meaningful feature embeddings. As new documents or code are introduced, the system extracts feature embeddings using the trained model and compares them with stored in a database. By measuring similarity (e.g., using cosine similarity or Euclidean distance) between the embeddings, the system can identify documents or code with similar structures and retrieve their associated known configuration parameters. This enables automated configuration recommendation based on past analyzed data.

At 606, the method 600 may include configuring the virtual environment based at least on one or more identified configuration parameters.

In some aspects, the virtual environment comprises an isolated, secure virtual environment (e.g., the virtual environment 170 shown in FIGS. 1 and 5) that operates as either a container or a virtual machine. A container, such as those managed by Docker or Kubernetes, shares the host OS kernel while encapsulating applications and dependencies, providing lightweight, efficient isolation. In contrast, a VM, like those powered by VMware or Hyper-V, includes a full OS stack, offering stronger isolation but with higher resource overhead. This isolation ensures security by preventing interference between applications, enhances portability by enabling deployment across different systems, and improves scalability by efficiently managing resources in cloud and on-premise environments.

In some aspects, configuring the virtual environment based at least on the identified hardware, software and/or runtime configuration, comprises: identifying and loading into the virtual environment one or more software libraries necessary for execution of the software code.

At 608, the method 600 may include executing the software code in the virtual environment and collecting an execution log of the software code.

In some aspects, executing the software code comprises checking the software code for malware and/or security vulnerabilities; and based on a determination that the software code contains malware and/or serious security vulnerabilities, terminating execution of the software code. Executing the software code involves an initial security check to detect malware and vulnerabilities before execution. This process uses static and dynamic analysis tools, such as antivirus scanners, signature-based detection, and AI-powered behavioral analysis, to identify malicious code or critical security flaws. If malware or serious vulnerabilities are detected, execution is immediately terminated to prevent system compromise, data breaches, or unauthorized access.

At 610, the method 600 may include determining whether the code executes correctly.

Based on determination that the code does not execute correctly, at 612, the method 600 may include analyzing the execution log using a second prepared MLM (e.g., troubleshooting MLM 130 from FIG. 1 or prepared troubleshooting MLM 227e from FIGS. 2 and 5) to identify configuration parameters of the virtual environment associated with a cause of failure in execution of the software code.

In some aspects, the second prepared MLM corresponds to LLM.

Based on determination that the code executes correctly, optionally, at 616, the method 600 may include displaying the execution log on a UI.

At 614, the method 600 may include modifying the identified configuration parameters of the virtual environment and executing the software code in the modified virtual environment.

At 616, the method 600 may include displaying the execution log on a user interface (UI).

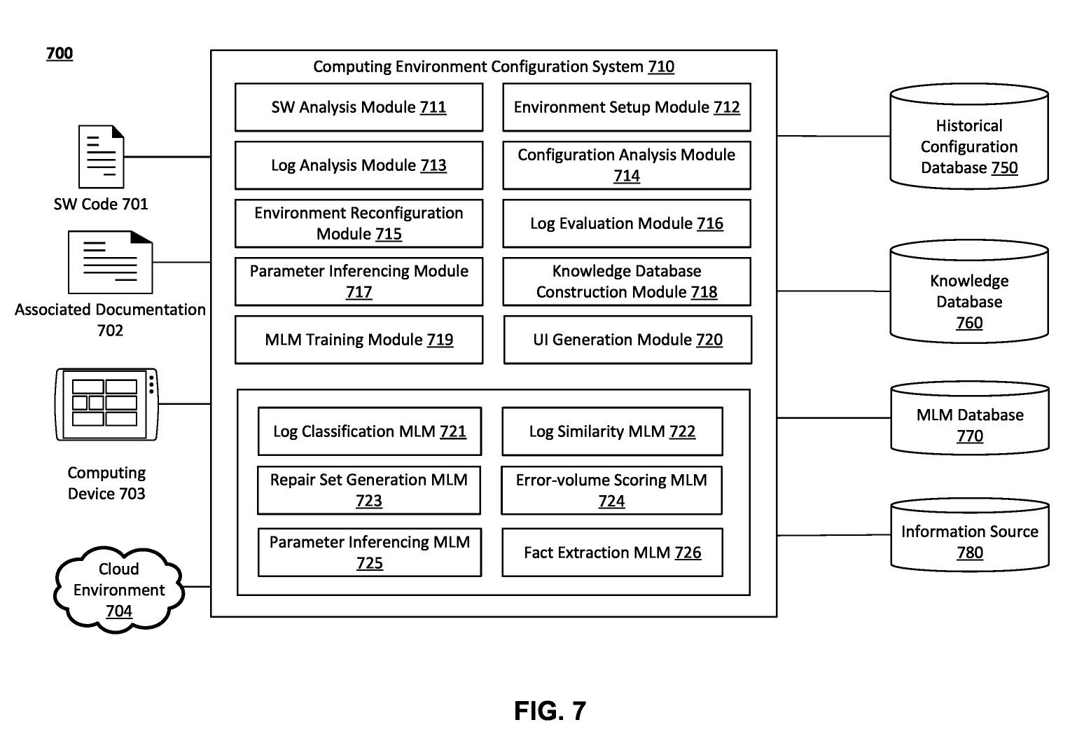

As described above with reference to FIGS. 1-6, the infrastructure configuration engine 106 and system 100 provide ML-based analysis of scientific or technical documents 102 and associated software code 103 to identify configuration parameters and troubleshoot execution failures within a virtual environment 170. This disclosure further extends the above-described systems and methods by providing additional machine learning (ML)-based techniques for automated configuration and repair of the same virtual computing environments 170 described above, without requiring any associated scientific or technical document. For example, a computing environment configuration system 710 (described below with reference to FIG. 7) may receive arbitrary software code, automatically configure computing environments 170 (e.g., configure the correct software dependencies, hardware resources, and/or runtime parameters) for executing the software code, diagnose configuration-related failures from execution logs, and iteratively repair the computing environment 170 by leveraging a database of prior configuration experience, thereby reducing setup time, minimizing human error, and improving the reproducibility and reliability of software execution across diverse virtual computing environments 170. As described below, the system 710 operates on the same virtual environments 170 provisioned and managed by the infrastructure configuration engine 106 described above, and may reuse the same cloud environment 138, software library database 150, and MLM training infrastructure described with reference to FIGS. 1-2.

FIG. 7 shows a computing environment configuration system 710 for ML-based automated configuration and repair of virtual computing environments 170. The system 710 extends the infrastructure configuration engine 106 (FIG. 1) by adding capabilities for automated environment repair using historical execution log analysis and prior configuration reuse. Like the infrastructure configuration engine 106, the system 710 operates on virtual environments 170 that may include virtual machines, containers (e.g., Docker), and/or sandboxes. The system 710 may automatically configure and repair a computing environment 170 for executing software code 701, without requiring any associated scientific or technical document. Alternatively, an optional associated documentation 702 may be used together with the software code 701 by the system 710 for the automated configuration and repair of the computing environment 170. The associated documentation 702 may include, but is not limited to, various configuration files, README files, or comments embedded in the software code 701. In an aspect, the associated documentation 702 may correspond to the scientific or technical document 102 described above with reference to FIG. 1, such that the system 710 may leverage both the document-based analysis of the infrastructure configuration engine 106 and the log-based repair techniques described below.

The system 710 may be a software installed on or accessed (e.g., via a virtual machine, container, web application) on a computing device 703, or may be implemented as a hardware (e.g., processing circuitry) of the computing device 703, or may be implemented as computer-executable instructions stored in a non-transitory computer-readable storage medium and executed by the processing circuitry of the computing device 703.

The system 710 may be coupled with a cloud environment 704, a historical configuration database 750, a knowledge database 760, a machine learning model (MLM) database 770, and an information source 780.

In an aspect, one or more of the databases 750/760/770/780 may be hosted on the computing device 703 or a different computing device, or in the cloud environment 704.

In an aspect, the historical configuration database 750 may store a plurality of historical configuration records of computing environments 170, where each record documents both computing environment configuration changes and software-level adjustments applied during a prior software execution within a computing environment. Each record corresponds to a prior software execution and includes: (i) one or more historical execution logs for the prior software execution, capturing error messages, warnings, and system outputs generated during execution within the computing environment 170; (ii) one or more configuration repair sets, each including configuration changes previously applied to the computing environment 170 during the prior software execution, where the configuration changes may include modifications to installed software packages, library or interpreter versions, hardware resource allocations, environment variables, and/or runtime settings of the computing environment 170; and (iii) one or more indications each indicating whether a corresponding configuration repair set resolved execution failures of the prior software execution or produced new failures.

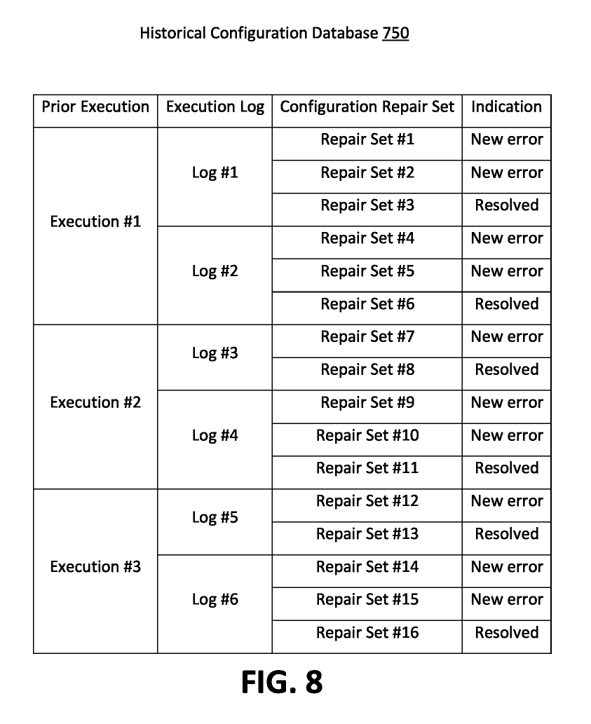

FIG. 8 shows an example of the historical configuration database 750 according to some aspects of this disclosure. As shown in FIG. 8, the historical configuration database 750 includes records of three prior executions of software within respective computing environments 170, each associated with two execution logs. Each execution log is associated with two or three configuration repair sets. Each configuration repair set includes one or more configuration changes to the computing environment 170 (e.g., installing or removing software packages, changing library versions, modifying environment variables, adjusting hardware resource allocations) and corresponds to an indication indicating whether the respective repair set has successfully resolved the execution failures or produced new failures.

The system 710 may query the historical configuration database 750 to identify prior software executions having execution logs similar to an execution log of a current software execution, and to retrieve configuration changes associated with those prior software executions that successfully resolved execution failures. By adapting the prior configuration changes to a current computing environment, the system 710 may reuse prior configuration experience to generate a current configuration repair set to resolve the current software execution failures, reducing the time and effort required to diagnose and repair configuration-related failures.

In an aspect, the knowledge database 760 may store configuration information for computing environments 170, including both environment-level and software-level configuration data. The configuration information may include, for example, supported library versions and their compatibility with specific operating systems and interpreter versions, required hardware capabilities (e.g., minimum GPU memory for specific libraries), known configuration incompatibilities between particular software packages or library versions within a computing environment 170, and recommended configuration parameter ranges or default values for specific types of software projects. The system 710 may retrieve relevant configuration information from the knowledge database 760 to provide as contextual input to the MLMs when selecting configuration parameters for a computing environment 170, diagnosing failures from execution logs, or inferring runtime parameters. By leveraging the configuration information, the MLMs can make more informed decisions about configuration changes based on established relationships between software elements and configuration parameters of the computing environment 170.

In an aspect, the MLM database 770 may store a plurality of trained MLMs, including serialized model weights, architectures, and associated metadata (e.g., training hyperparameters, dataset identifiers, and performance metrics). The MLM database 770 may be hosted on the computing device 703, on a remote server, or in the cloud environment 704, and may be accessed by the system 710 via an application programming interface (API). The system 710 may retrieve one or more of the stored MLMs from the MLM database 770 for automated configuration and repair of the computing environment 170. Further, the system 710 may train or update an MLM using the MLM training module 719 and store the trained or updated model into the MLM database 770. As an example, the system 710 may retrieve an MLM from the MLM database 770, update the retrieved MLM with new training data from the historical configuration database 750, and store the updated MLM back into the MLM database 770. As another example, the system 710 may train a new MLM and store the trained MLM into the MLM database 770.

In an aspect, the information source 780 may include an online documentation, a benchmark code repository, or a question-and-answer website. The system 710 may retrieve information from the information source 780 to assign severity scores to error messages in execution logs, to obtain descriptions of similar code patterns and their parameter settings, and to gather contextual information about library versions, hardware requirements, and known configuration incompatibilities. The information retrieved from the information source 780 may enhance the accuracy of the ML models in diagnosing configuration-related failures and inferring appropriate configuration changes.

The system 710 may include a plurality of modules used to execute the automated configuration and repair of the virtual computing environment 170. The plurality of modules may include a software analysis module 711, an environment setup module 712, a log analysis module 713, a configuration analysis module 714, an environment reconfiguration module 715, a log evaluation module 716, a parameter inferencing module 717, a knowledge database construction module 718, an MLM training module 719, and a UI generation module 720. The system 710 may further include a plurality of trained MLMs, such as a log classification MLM 721, a log similarity MLM 722, a repair set generation MLM 723, an error-volume scoring MLM 724, a parameter inferencing MLM 725, and a fact extraction MLM 726.

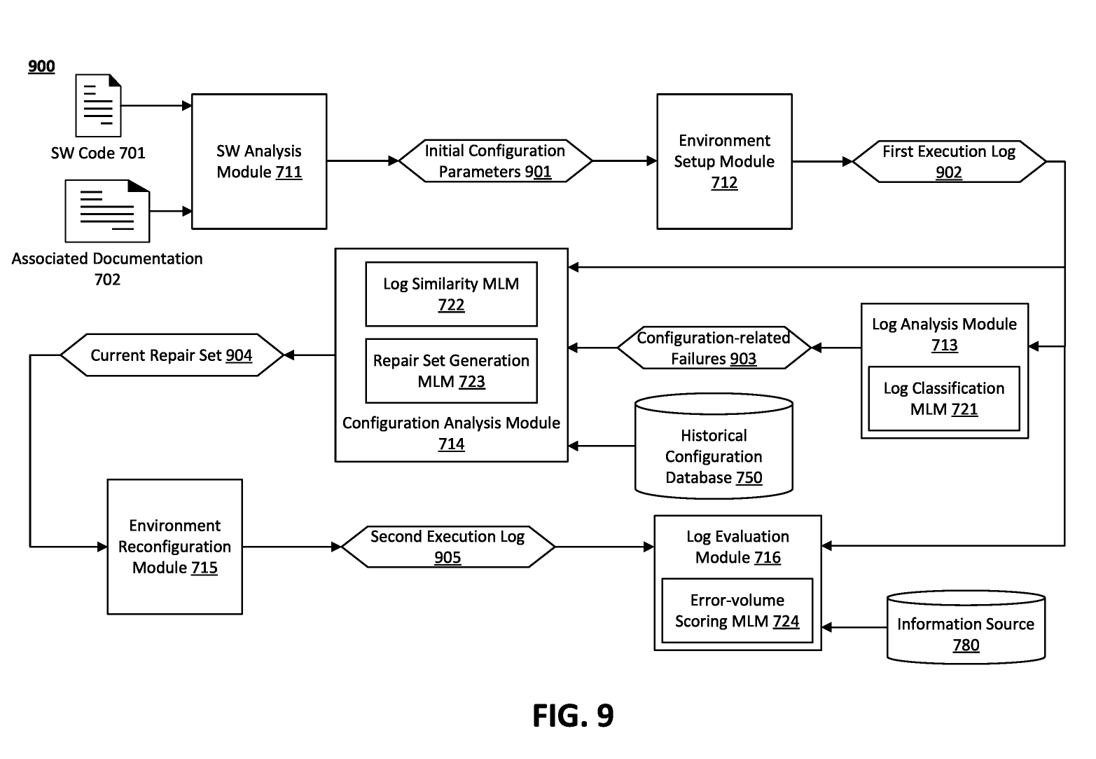

FIGS. 9-11 present detailed descriptions of the plurality of modules and MLMs.

FIG. 9 shows a process 900 for automated configuration and repair of computing environments 170 according to some aspects of the disclosure. The process 900 may be executed by the system 710.

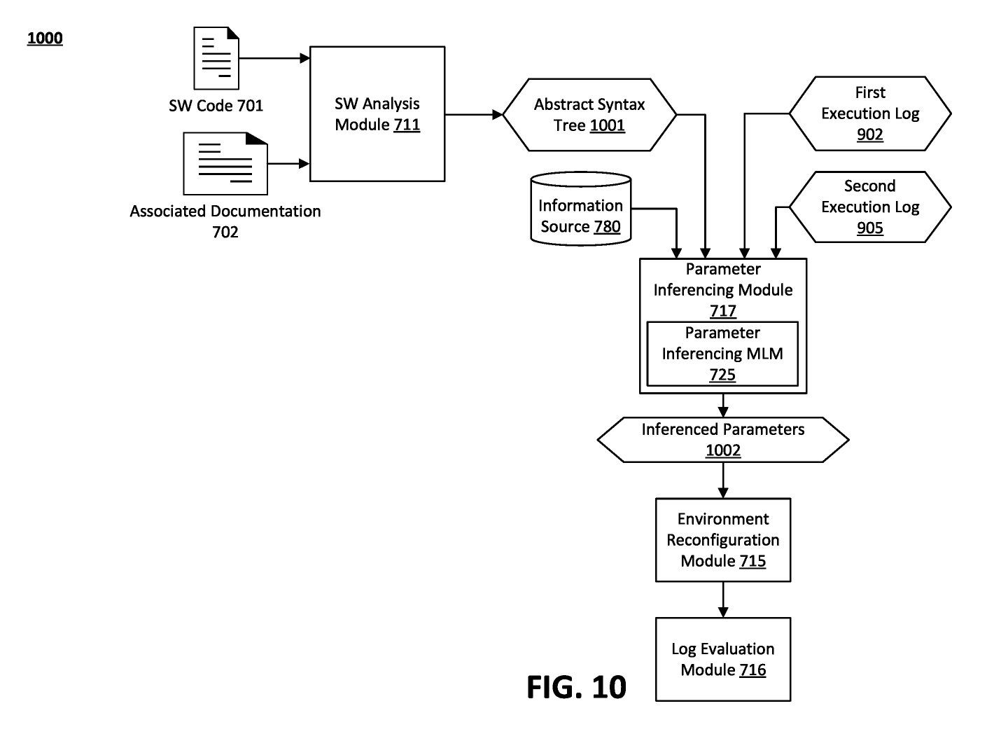

In an aspect, the system 710 may execute the software analysis module 711 to analyze the software code 701, and optionally the associated documentation 702. The software code 701 may include source code and/or executable code. The associated documentation 702 may include a configuration file or README file associated with the software code 701, or include comments embedded in the software code 701. When the associated documentation 702 is input into the system 710, the software analysis module 711 may extract documented runtime parameters (e.g., command line options, configuration keys, default values) from the associated documentation 702 and mark them as known runtime parameters. The software analysis module 711 may operate in a manner analogous to the optional software analysis MLM 124 described above with reference to FIG. 1, in that both modules analyze software code to identify subject matter, parameters, and dependencies. However, the software analysis module 711 is further configured to perform static code analysis—including parsing source code files to construct an in-memory representation of the code structure (e.g., an abstract syntax tree)—to detect dependency statements, identify configuration parameters, and extract runtime parameter usage patterns, as described below with reference to FIG. 10.

The software analysis module 711 may analyze the software code 701 to detect dependency statements in the software code 701 by performing static code analysis. Specifically, the software analysis module 711 may parse the source code files of the software code 701 to construct an abstract syntax tree (AST) representing the syntactic structure of the code. The software analysis module 711 may then traverse the AST to identify nodes corresponding to dependency statements. A dependency statement may indicate that the software code 701 requires an external library, package, or module to execute. Examples of the dependency statement may include an import statement (e.g., "import numpy" in Python), an include directive (e.g., "#include <stdio.h>" in C/C++), and a package reference (e.g., "require 'json'" in Ruby or package declarations in a package.json file). For each identified dependency statement, the software analysis module 711 may extract the library or package name, and optionally a version constraint, from the AST node. The software analysis module 711 may additionally scan configuration manifest files (e.g., requirements.txt, setup.py, package.json, Gemfile) within the software code 701 or associated documentation 702 to identify additional dependencies not declared in the source code itself. From the software code 701 and the optional associated documentation 702, the software analysis module 711 may identify initial configuration parameters 901 for configuring a computing environment 170. The initial configuration parameters 901 may include: software configuration parameters such as required software libraries detected from the dependency statements, library versions, and interpreter versions; hardware configuration parameters such as CPU/GPU usage and memory requirements when inferable from the code or documentation; and runtime configuration parameters such as environment variables, execution flags, and number of worker processes.

Based on the initial configuration parameters 901, the system 710 may execute the environment setup module 712 to configure a computing environment for executing the software code 701. The environment setup module 712 may create a new computing environment based on the initial configuration parameters 901, or may select an existing computing environment from a pool of pre-configured environments that matches the initial configuration parameters 901. The computing environment may include a virtual machine, a container (e.g., Docker), and/or a sandbox. The environment setup module 712 may configure the computing environment by applying the initial configuration parameters 901. For example, the environment setup module 712 may apply the software configuration parameters by using a package manager (e.g., pip, npm, apt) to install the required software libraries and/or packages identified from the dependency statements. The environment setup module 712 may apply the hardware configuration parameters by allocating CPU cores, assigning GPU resources, reserving memory capacity, and/or provisioning storage space for the computing environment. The environment setup module 712 may apply the runtime configuration parameters by setting environment variables (e.g., PYTHONPATH, JAVA_HOME, LD_LIBRARY_PATH), configuring execution flags, specifying the number of worker processes or threads, and/or setting timeout values.

The system 710 may execute the software code 701 within the configured computing environment and collect a first execution log 902 generated during the execution of the software code 701. The first execution log 902 may include error messages, warnings, and/or system outputs. For example, the error messages may include "ModuleNotFoundError: No module named 'numpy'" indicating a missing library, "MemoryError: Unable to allocate array" indicating insufficient memory, or "CUDA error: no CUDA-capable device is detected" indicating missing GPU support. The warnings may include "DeprecationWarning: This function is deprecated" or "UserWarning: GPU memory is running low." The system outputs may include standard output (stdout) messages, standard error (stderr) messages, runtime performance metrics, and/or resource utilization information.

In an aspect, the software analysis module 711 may optionally generate a minimal test program that includes the detected dependency statements and minimal surrounding code required to execute the dependency statements. The system 710 may execute either the minimal test program or the full software code 701 in the configured computing environment. When the minimal test program is executed first, the system 710 may collect a test execution log that may be used as at least part of the first execution log 902. This approach may allow the system 710 to identify and resolve dependency-related configuration issues before attempting to execute the full software code 701.

The system 710 may execute the log analysis module 713 to analyze the first execution log 902. The log analysis module 713 is a coordinating module that orchestrates the analysis of execution logs by performing pre-processing steps and invoking one or more trained MLMs to classify and diagnose failures. Specifically, the log analysis module 713 may first pre-process the first execution log 902 by parsing the raw log text to segment it into individual log entries, filtering out non-informative entries (e.g., routine status messages, progress bars), and normalizing the log format (e.g., standardizing timestamps, removing ANSI color codes). The log analysis module 713 may then provide the pre-processed first execution log 902 to the log classification MLM 721 for classification and failure identification.

The log classification MLM 721 is a trained machine learning model, such as a large language model (LLM) or a neural network (e.g., a transformer-based classifier), that has been trained on a dataset of annotated execution logs. The training dataset includes execution logs labeled with corresponding failure types and root causes, such that the log classification MLM 721 learns to associate patterns in log content with specific categories of configuration-related failures. To classify and identify failures, the log classification MLM 721 may tokenize the pre-processed execution log into individual words or subwords using a tokenizer (e.g., byte-pair encoding or WordPiece), generate contextual embeddings for each token using the transformer encoder layers, extract features such as error codes, exception types, library names, and version numbers from the embeddings, and compare the extracted features against patterns learned during training. The log classification MLM 721 may assign a probability score to each possible failure category and select the category with the highest probability. Failure categories may include, for example, configuration-related failures such as missing libraries, version mismatches, unsupported operating systems, hardware incompatibilities, permission and access errors, invalid argument values, or missing configuration entries. The log analysis module 713 may receive the classification results from the log classification MLM 721 and aggregate them into a structured failure report including the identified failure categories, their associated probability scores (hereinafter referred to as “confidence scores”), and the specific log entries that triggered each classification.

The log classification MLM 721 may be trained using a supervised learning procedure on the dataset of annotated execution logs described above. During training, each execution log in the training dataset may be associated with a ground-truth label indicating the failure type and root cause. The training procedure may use a cross-entropy loss function that measures the difference between the predicted probability distribution over failure categories and the ground-truth label. The model parameters may be updated using an optimizer such as Adam or stochastic gradient descent (SGD). The training dataset may be split into training, validation, and test sets, and the log classification MLM 721 may be trained over multiple epochs until convergence is achieved on the validation set. The trained log classification MLM 721 may be stored in the MLM database 770 by the MLM training module 719. In this manner, the log classification MLM 721 provides a technical improvement over conventional manual log analysis by processing execution logs that may contain hundreds or thousands of individual log entries with cascading, interdependent error patterns, and identifying co-occurring failure signatures across these entries in a single forward pass through the transformer encoder layers. This capability enables the system 710 to diagnose complex, multi-factor configuration failures that involve interactions between multiple software components, library versions, and hardware configurations simultaneously — a volume and complexity of pattern matching that would require prohibitive time and computational resources if performed through sequential rule-based parsing or manual inspection.

Based on the analysis, the log classification MLM 721 may identify the configuration-related failures 903 and propose one or more initial configuration changes to the computing environment, such as installing a missing package, adjusting a library or interpreter version, or setting or changing an environment variable. For example, the log classification MLM 721 may parse an error message such as "ModuleNotFoundError: No module named 'numpy'" and propose installing the numpy package using a package manager command (e.g., "pip install numpy"). As another example, the log classification MLM 721 may parse an error message such as "ImportError: numpy requires Python 3.8 or higher" and propose upgrading the Python interpreter version. Yet another example, the log classification MLM 721 may parse an error message such as "CUDA error: no CUDA-capable device is detected" and propose enabling GPU resources in the computing environment or setting a runtime flag to use CPU instead.

The system 710 may apply the initial configuration changes to the computing environment 170 and then re-execute the software code 701. When the re-execution fails, the system 710 may execute the configuration analysis module 714 to generate a current repair set 904 including configuration changes to the computing environment 170 generated by using prior configuration experience. To use the prior configuration experience, the configuration analysis module 714 may provide the first execution log 902 to the log similarity MLM 722, which is configured to query the historical configuration database 750 to compare the first execution log 902 with historical execution logs stored in the historical configuration database 750. As described above, the historical configuration database 750 may store a plurality of historical configuration records documenting both computing environment configuration changes and software-level adjustments applied during prior software executions within computing environments 170. Each record corresponds to a prior software execution and includes: (i) one or more historical execution logs for the prior software execution; (ii) one or more configuration repair sets, each including configuration changes previously applied to the computing environment 170 during the prior software execution; and (iii) one or more indications each indicating whether a corresponding configuration repair set resolved the execution failures of the prior software execution or produced new failures. FIG. 8 shows an example of the historical configuration database 750.

To compare the first execution log 902 with the historical execution logs, the log similarity MLM 722 may convert each of the first execution log 902 and the historical execution logs into a numerical vector representation (e.g., an embedding) that captures semantic features of log content of the respective execution log. The log similarity MLM 722 may generate the embedding by processing the execution log through an encoder network, such as a transformer-based encoder, that maps the log content into a high-dimensional vector space. The log similarity MLM 722 may then compute a similarity score between the embedding of the first execution log 902 and the embeddings of the historical execution logs, such that the historical execution logs having similar failure patterns with the first execution log 902 can be identified. The similarity score may be computed using a distance metric such as cosine similarity or Euclidean distance. To identify the historical execution logs having the similar failure patterns with the first execution log 902, the log similarity MLM 722 may select one or more historical execution logs having similarity scores above a predefined threshold, or may select the top-k historical execution logs with the highest similarity scores. The log similarity MLM 722 may retrieve configuration changes associated with the selected historical execution logs that successfully resolved execution failures.

The log similarity MLM 722 may be trained using a contrastive learning or metric learning procedure on pairs of execution logs from the historical configuration database 750. During training, execution logs associated with similar failure patterns and resolution paths may be treated as positive pairs, while execution logs associated with dissimilar failure patterns may be treated as negative pairs. The log similarity MLM 722 may be trained to minimize the embedding distance between positive pairs and maximize the embedding distance between negative pairs using a contrastive loss function (e.g., triplet loss or noise-contrastive estimation loss). The training procedure may use an optimizer such as Adam, and the model may be trained over multiple epochs until the validation loss converges. The trained log similarity MLM 722 may be stored in the MLM database 770 by the MLM training module 719. By mapping high-dimensional, unstructured log data into a compact embedding space, the log similarity MLM 722 reduces the computational cost of searching across large historical databases compared to pairwise full-text comparison. Additionally, the learned embedding space enables retrieval of semantically similar logs even when the surface-level text differs — for example, when different library names produce analogous failure patterns or when equivalent errors are expressed in different formats across different operating systems or runtime environments. This dimensionality reduction and learned semantic similarity matching constitute a concrete improvement in the efficiency of computing resource utilization for historical log retrieval.

To generate the current repair set 904, the configuration analysis module 714 may provide to the repair set generation MLM 723 the identified configuration-related failures, a current environment state of the computing environment, and the retrieved prior configuration changes associated with the selected historical execution logs. The current environment state may include current configuration parameters of the computing environment, such as installed software packages and their versions, hardware resource allocations (e.g., CPU cores, GPU assignments, memory capacity), runtime settings (e.g., environment variables, execution flags), and operating system information.

The repair set generation MLM 723 may be configured to adapt the prior configuration changes to the current environment state of the computing environment to generate one or more configuration changes to the computing environment. To adapt the prior configuration changes, the repair set generation MLM 723 may compare the current environment state with the environment state associated with the prior configuration changes, identify differences between the two environment states, and modify the prior configuration changes to account for the identified differences. For example, the repair set generation MLM 723 may adjust package versions to match compatibility requirements of the current environment, substitute equivalent packages when the original packages are not available for the current operating system, update file paths or directory structures to match the current environment, and/or modify environment variable values based on the current hardware configuration. The repair set generation MLM 723 may construct a prompt or input representation that combines the identified configuration-related failures, the current environment state, and the prior configuration changes, and process the combined input through a generative model, such as an LLM or a sequence-to-sequence neural network, to generate the one or more configuration changes.

The repair set generation MLM 723 may be trained using a supervised sequence generation procedure on historical configuration records from the historical configuration database 750. Each training example may include, as input, a prior environment state, a set of identified configuration-related failures, and a prior configuration repair set associated with a different environment state, and, as output, an adapted configuration repair set that accounts for the differences between the prior and target environment states. The repair set generation MLM 723 may be trained using teacher forcing, where the model generates output tokens sequentially and the training loss (e.g., cross-entropy loss over output tokens) is computed by comparing each generated token against the ground-truth adapted repair set. The model parameters may be updated using an optimizer such as Adam. The training dataset may be constructed from the historical configuration database 750 by pairing configuration repair sets that successfully resolved failures in one environment with corresponding target environments having different configurations, thereby enabling the model to learn environment-aware adaptation of configuration changes. The trained repair set generation MLM 723 may be stored in the MLM database 770 by the MLM training module 719.

The current repair set 904 may include a script containing the one or more configuration changes in the form of shell commands, package-manager commands, and/or configuration file edits.

The system 710 may execute the environment reconfiguration module 715 to apply the current repair set 904 to modify the computing environment. For example, the environment reconfiguration module 715 may apply the script to modify the computing environment 170. The script may include installing or removing packages, changing versions, or setting environment variables. The system 710 may re-execute the software code 701 within the modified computing environment and collect a second execution log 905 during the re-execution of the software code 701.

To evaluate the effectiveness of the applied configuration changes, the system 710 may execute the log evaluation module 716 to evaluate the second execution log 905 against the first execution log 902. The log evaluation module 716 may calculate a first error-volume metric for the first execution log 902 and a second error-volume metric for the second execution log 905, and compare the first error-volume metric with the second error-volume metric.

To calculate an error-volume metric, the log evaluation module 716 may parse the execution log to identify error messages, count the total number of errors, and/or categorize the errors by error type. The error-volume metric may represent at least one of the number of errors, the severity of errors, or the distribution of error types. For example, the error-volume metric may be calculated as a weighted sum of errors, where each error is multiplied by a weight corresponding to its severity level (e.g., critical errors may have a weight of 10, warnings may have a weight of 1). As another example, the error-volume metric may be calculated as a vector representing the count of errors in each error category (e.g., [missing library errors: 2, version mismatch errors: 1, permission errors: 0]), and the magnitude of the vector may be used for comparison. It is noted that both the first and second error-volume metric calculations may use the same scheme.

If the second error-volume metric is less than the first error-volume metric, the system 710 may accept the current repair set 904 and treat the modified computing environment as the current baseline computing environment. If the second error-volume metric is not less than the first error-volume metric (e.g., the error volume is not reduced or becomes worse), the system 710 may undo or disregard the current repair set 904 and select a different candidate configuration repair set from an alternative similar historical log in the historical configuration database 750. To select the different candidate configuration repair set, the system 710 may retrieve a ranked list of similar historical logs identified by the log similarity MLM 722, where the historical logs are ranked by similarity score. If the current repair set 904 was derived from the highest-ranked historical log and did not reduce the error volume, the system 710 may select the next highest-ranked historical log from the ranked list and retrieve its associated configuration repair set. Alternatively, the system 710 may exclude the historical log associated with the failed current repair set 904 from consideration and re-query the historical configuration database 750 to identify a different similar historical log. The system 710 may then provide the different historical log and its associated configuration repair set to the repair set generation MLM 723 to generate a new candidate configuration repair set adapted to the current environment state. The system 710 may iterate this loop until the software code 701 executes successfully or a termination condition is met, such as a maximum number of iterations or exhaustion of candidate historical logs.

In an aspect, the log evaluation module 716 may use an error-volume scoring MLM 724 to assign error-volume scores (e.g., severity scores) to the identified error messages. To calculate error-volume scores, the error-volume scoring MLM 724 may analyze each error message in the execution log and assign a numerical severity score based on the potential impact of the error on software execution. The error-volume scoring MLM 724 may determine the severity score by classifying the error message into a severity category (e.g., critical, high, medium, low), by comparing the error message against known error patterns with predefined severity scores, and/or by querying the information source 780 such as online documentation, benchmark repositories, or question-and-answer websites to assess the severity of the error. For example, an error message indicating a missing core library may receive a high severity score, while a deprecation warning may receive a low severity score. The error-volume scoring MLM 724 may aggregate the individual error-volume scores into the error-volume metric by summing the scores, calculating an average score, or computing a weighted combination based on error categories.

The error-volume scoring MLM 724 may be trained using a supervised learning procedure on a dataset of error messages labeled with ground-truth severity scores. The ground-truth severity scores may be determined by domain experts or derived from the historical configuration database 750 — for example, errors that required more extensive configuration changes to resolve or that caused cascading failures in subsequent execution steps may receive higher severity scores. The training procedure may use a regression loss function (e.g., mean squared error) or a classification loss function (e.g., cross-entropy loss) depending on whether the severity scores are continuous or categorical. The model parameters may be updated using an optimizer such as Adam. The trained error-volume scoring MLM 724 may be stored in the MLM database 770 by the MLM training module 719.

In an aspect, the log evaluation module 716 may be applicable to evaluate the initial configuration changes proposed by the log classification MLM 721. For example, after the system 710 applies the initial configuration changes proposed by the log classification MLM 721 and re-executes the software code 701, the log evaluation module 716 may calculate an error-volume metric for the execution log generated during the re-execution. The log evaluation module 716 may compare this error-volume metric with the error-volume metric of the first execution log 902 to determine whether the initial configuration changes reduce the error volume. If the error volume is reduced, the system 710 may accept the initial configuration changes and continue execution or proceed to address remaining errors. If the error volume is not reduced, the system 710 may disregard the initial configuration changes and proceed to use the configuration analysis module 714 to generate candidate configuration changes based on prior configuration experience from the historical configuration database 750. In this way, the system 710 may first attempt to resolve configuration-related failures using the initial configuration changes proposed by the log classification MLM 721, and if unsuccessful, may leverage prior configuration experience to generate the candidate configuration changes.

In an aspect, the system 710 may execute the configuration analysis module 714 without applying the initial configuration changes proposed by the log classification MLM 721. For example, when the first execution log 902 indicates a complex configuration-related failure that is unlikely to be resolved by straightforward heuristics, the system 710 may skip the applying of the initial configuration changes and proceed directly to the configuration analysis module 714. This approach may be more efficient when the log classification MLM 721 determines that the failure pattern matches known complex failures that required prior configuration experience to resolve. Alternatively, the system 710 may be configured by a user or administrator (e.g., through a UI generated by the UI generation module 720) to always use the configuration analysis module 714 to leverage prior configuration experience for all configuration-related failures, bypassing the applying of the initial configuration changes. In another aspect, the system 710 may determine whether to apply initial configuration changes or proceed directly to the configuration analysis module 714 based on the confidence scores generated by the log classification MLM 721 as described above. For example, when the log analysis module 713 aggregates the classification results from the log classification MLM 721, each identified failure category is associated with a confidence score representing the probability that the classification is correct. A low confidence score (e.g., below a configurable threshold) may indicate that the initial configuration changes proposed by the log classification MLM 721 are unlikely to resolve the failure, and the system 710 may proceed directly to the configuration analysis module 714 to leverage prior configuration experience instead.

As described above with respect to FIG. 9, the system 710 may automatically configure and repair a computing environment by identifying and resolving configuration-related failures such as missing libraries, version mismatches, and hardware incompatibilities. However, even after the computing environment is correctly configured with the appropriate software libraries, hardware resources, and environment settings, the software code 701 may still fail to execute correctly or produce unsatisfactory results due to incorrect or missing runtime and/or input parameters. Unsatisfactory results may include, for example, incorrect output, low model accuracy, failure to converge, or output values outside expected ranges. Runtime parameters, such as environment variables, execution flags, number of worker processes, timeout values, and memory limits, may control how the software executes. Input parameters, such as learning rate, batch size, input file paths, dataset names, and algorithm-specific settings, may be values that the software processes or uses for computation. Both runtime and input parameters may significantly affect the behavior and output of the software code 701. For example, a machine learning training script may fail due to an incorrect runtime parameter such as an insufficient memory limit, or may produce poor results (e.g., low model accuracy or failure to converge) due to an incorrect input parameter such as an inappropriate learning rate or batch size. Similarly, a data processing script may fail due to an incorrect runtime parameter such as an insufficient number of working processes, or may produce incorrect output due to an incorrect input parameter such as an incorrectly specified input file path. To address these runtime and input parameter failures, the system 710 may perform runtime and input parameter inference to infer revised values for known parameters and/or discover new parameters required for correct execution

FIG. 10 shows a process 1000 for runtime and input parameter inference according to some aspects of this disclosure. The process 1000 may be executed by the system 710. The system 710 may treat runtime/input parameters explicitly specified in documentation or configuration files as known parameters, while parameters discovered or suggested by the system may be treated as new parameters.

In an aspect, the system 710 may perform runtime and input parameter inference when execution continues to fail or produces unsatisfactory results under known parameters extracted from documentation or configuration files. For example, the software code 701 may fail due to an incorrect runtime parameter such as an insufficient memory limit or an incorrect number of worker processes. Alternatively, the software code 701 may produce unsatisfactory results due to an incorrect input parameter such as an inappropriate learning rate or batch size for a machine learning model.

To perform runtime and input parameter inference, the system 710 may execute the software analysis module 711 to construct an abstract syntax tree 1001 of the software code 701 and identify code elements whose behavior depends on runtime and/or input parameters. For runtime parameters, the software analysis module 711 may identify code elements such as resource allocation calls, process spawning functions, and timeout configurations. For input parameters, the software analysis module 711 may identify code elements such as conditional branches that check parameter values, function arguments that receive parameter inputs, and variable assignments that use parameter values for computation. The system 710 may retrieve information from the information source 780, including public code repositories, README files, comments, and question-and-answer websites, about similar code patterns and their typical runtime and/or input parameter settings.

The system 710 may execute the parameter inferencing module 717 including the parameter inferencing MLM 725 that is configured to use the abstract syntax tree (AST), the execution logs (e.g., first execution log 902 and second execution log 905), and the information retrieved from the information source 780 to infer revised values for known runtime/input parameters and/or new runtime/input parameters required for correct execution. An AST may be a tree representation of the syntactic structure of the software code 701, where each node in the tree represents a construct in the code, such as a function declaration, a variable assignment, a conditional statement, or a loop. The AST may allow the parameter inferencing MLM 725 to understand the structure and logic of the software code 701 without executing it, and to identify how parameters are used throughout the code. For runtime parameters, the parameter inferencing MLM 725 may infer values such as optimal memory limits based on the software code's data structures, appropriate number of worker processes based on the computational workload, and suitable timeout values based on expected execution duration. For input parameters, the parameter inferencing MLM 725 may infer values such as recommended learning rates based on the model architecture, appropriate batch sizes based on available memory and dataset size, and correct file paths based on project directory structure.

The parameter inferencing MLM 725 may be trained using a supervised learning procedure on a dataset of software projects with known successful runtime and input parameter configurations. The training dataset may be constructed from the historical configuration database 750 and/or the knowledge database 760, where each training example includes a code structure representation derived from the abstract syntax tree of a software project, execution context information (e.g., hardware resources, operating system, installed libraries), and ground-truth parameter values that produced successful execution or satisfactory results. The training procedure may use a loss function appropriate to the parameter type — for example, mean squared error for continuous parameters such as learning rates or memory limits, and cross-entropy loss for categorical parameters such as execution flags or device selection. The model parameters may be updated using an optimizer such as Adam. The trained parameter inferencing MLM 725 may be stored in the MLM database 770 by the MLM training module 719. The parameter inferencing MLM 725 provides a technical improvement over manual parameter tuning by performing semantic analysis of code structure through the abstract syntax tree to understand how parameters propagate through computation graphs, enabling it to infer parameter values that account for interdependencies between multiple code paths. Because the number of possible parameter combinations grows exponentially with the number of code paths and parameter dimensions, exhaustive manual analysis or brute-force search would require prohibitive computing time and memory resources for non-trivial software projects. The parameter inferencing MLM 725 reduces this combinatorial search space by leveraging learned representations of code structure and parameter relationships to predict effective parameter values directly, thereby reducing the computational resources required for parameter optimization.

The system 710 may execute the environment reconfiguration module 715 to apply the inferred runtime/input parameter values 1002 to the computing environment, re-execute the software code 701, and collect execution logs. The system 710 may execute the log evaluation module 716 to evaluate the error-volume metric of the collected logs. The system 710 may retain parameter changes that reduce the error-volume metric and discard those that do not. To retain parameter changes, the system 710 may update the known parameters with the inferred values and store the updated parameters in the computing environment for subsequent executions. To discard parameter changes, the system 710 may revert the parameters to their previous values and select a different set of candidate parameter values from the parameter inferencing MLM 725. The system 710 may iterate this process until the software code 701 executes successfully with satisfactory results or a termination condition is met, such as a maximum number of iterations or exhaustion of candidate parameter values.

In an aspect, the processes 900 and 1000 may be performed together. As an example, the process 1000 may be performed after the process 900 when the system 710 determines that the execution continues to fail after the process 900. As another example, the process 1000 may be performed in parallel with the process 900 when the system 710 determines that both environment configuration and runtime/input parameter issues may be contributing to execution failures.

In an aspect, the processes 900 and 1000 may be performed separately. As an example, the process 900 may be performed alone when the system 710 determines that only the environment configuration may be contributing to the execution failures. As another example, the process 1000 may be performed alone when the system 710 determines that only runtime/input parameter issues may be contributing to the execution failures.

As described above with respect to FIGS. 9 and 10, the system 710 may use various MLMs to diagnose configuration-related failures, generate configuration repair sets, and infer runtime/input parameters. The accuracy and effectiveness of these MLMs may depend on the availability of relevant contextual information about software dependencies, hardware requirements, known incompatibilities, and recommended parameter settings. To provide this contextual information, the system 710 may construct and maintain the knowledge database 760 that stores configuration information extracted from code repositories. The knowledge database 760 may enable the MLMs to make more informed decisions by providing information such as which library versions are compatible with specific operating systems, which hardware capabilities are required for certain software packages, which configuration parameters are commonly used for specific types of software projects, and which parameter values have been successful in similar software projects. By leveraging the knowledge database 760, the system 710 may improve the success rate of configuration and repair operations and reduce the number of iterations required to achieve successful execution of the software code 701.

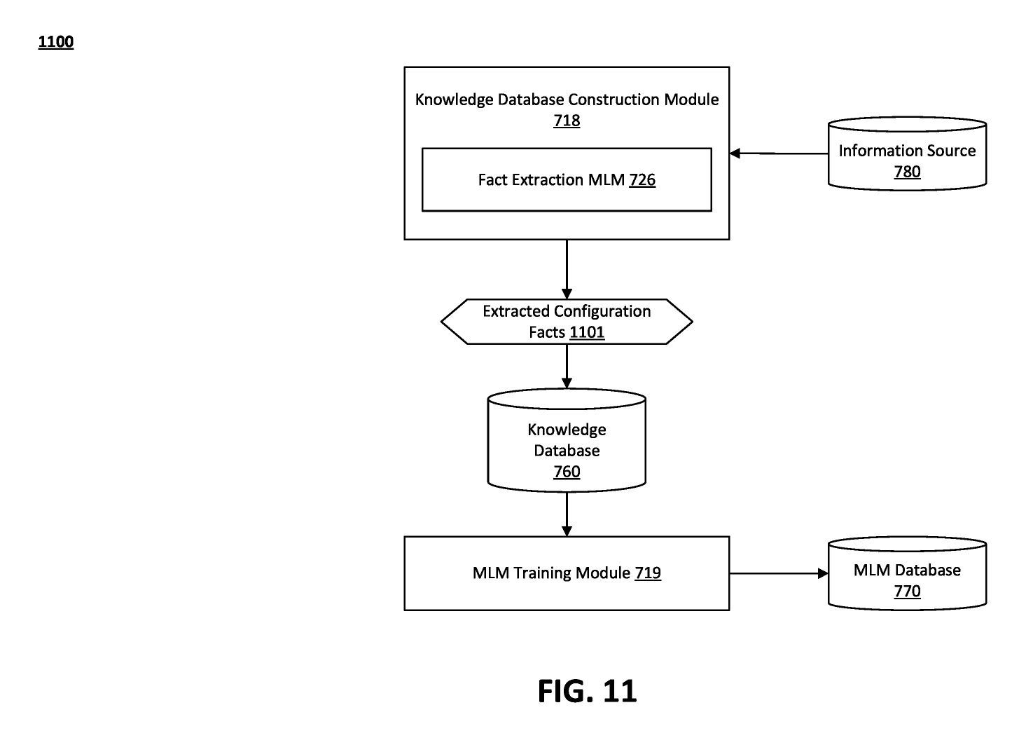

FIG. 11 shows a process 1100 for construction of the knowledge database 760 according to some aspects of this disclosure. The process 1100 may be executed by the system 710. The process 1100 may be performed periodically to update the knowledge database 760 with new configuration information, or may be performed on-demand when the system 710 encounters a new software project or dependency that is not covered by the existing knowledge database 760.

In an aspect, the system 710 may execute the knowledge database construction module 718 to crawl one or more code repositories associated with various software projects (e.g., from the information source 780) to obtain repository data. The repository data may include at least source code, commit history, branches, documentation files, issue reports, and/or mailing list messages. For example, the knowledge database construction module 718 may crawl public code repositories such as GitHub, GitLab, or Bitbucket to obtain repository data from open-source software projects. The knowledge database construction module 718 may also crawl internal code repositories within an organization to obtain repository data from proprietary software projects.

The knowledge database construction module 718 may provide the repository data to the fact extraction MLM 726 that is configured to extract configuration information 1101 from the repository data. The configuration information 1101 may include, for example, supported library versions, required hardware capabilities, known incompatibilities between specific library versions, recommended parameter ranges or defaults, and common configuration patterns for specific types of software projects. The fact extraction MLM 726 may analyze the repository data to identify relationships between software elements and configuration parameters, and may discard the repository data that is not relevant to environment configuration or runtime/input parameters.

The fact extraction MLM 726 may be trained using a supervised learning procedure on a dataset of repository documents annotated with configuration-relevant facts. The training dataset may include source code files, documentation pages, issue reports, and mailing list messages, where each document is annotated with ground-truth labels indicating the locations and types of configuration-relevant facts, such as supported library version statements, hardware requirement specifications, known incompatibility descriptions, and recommended parameter values. The fact extraction MLM 726 may be trained using a named-entity recognition or relation extraction training objective, where the model learns to identify and classify spans of text that correspond to configuration-relevant facts. The training procedure may use a token-level cross-entropy loss function and an optimizer such as Adam. The trained fact extraction MLM 726 may be stored in the MLM database 770 by the MLM training module 719.

The system 710 may store the extracted configuration information 1101 into the knowledge database 760 as structured records or documents. The structured records or documents may be indexed by software project name, dependency name, library version, and/or parameter name to enable efficient retrieval of relevant configuration information. For example, when the system 710 encounters a missing library failure involving a specific library, the system 710 may query the knowledge database 760 using the library name to retrieve configuration information about supported versions, known incompatibilities, and recommended installation procedures for that library.

The system 710 may supply relevant configuration information from the knowledge database 760 as contextual input to the MLM training module 719 that is configured to train the log classification MLM 721, the log similarity MLM 722, the configuration change generation MLM 723, the error-volume scoring MLM 724, and/or the parameter inferencing MLM 725. The MLM training module 719 may store the trained MLMs into the MLM database 770. The contextual input may enhance the accuracy of the MLMs in diagnosing failures, generating configuration repair sets, scoring error severity, and inferring runtime/input parameters by providing relevant background knowledge about software dependencies and configuration requirements.

In an aspect, the system 710 may execute the UI generation module 720 to receive inputs from a user and to display execution logs/configuration-related failures/runtime and input parameter issues.

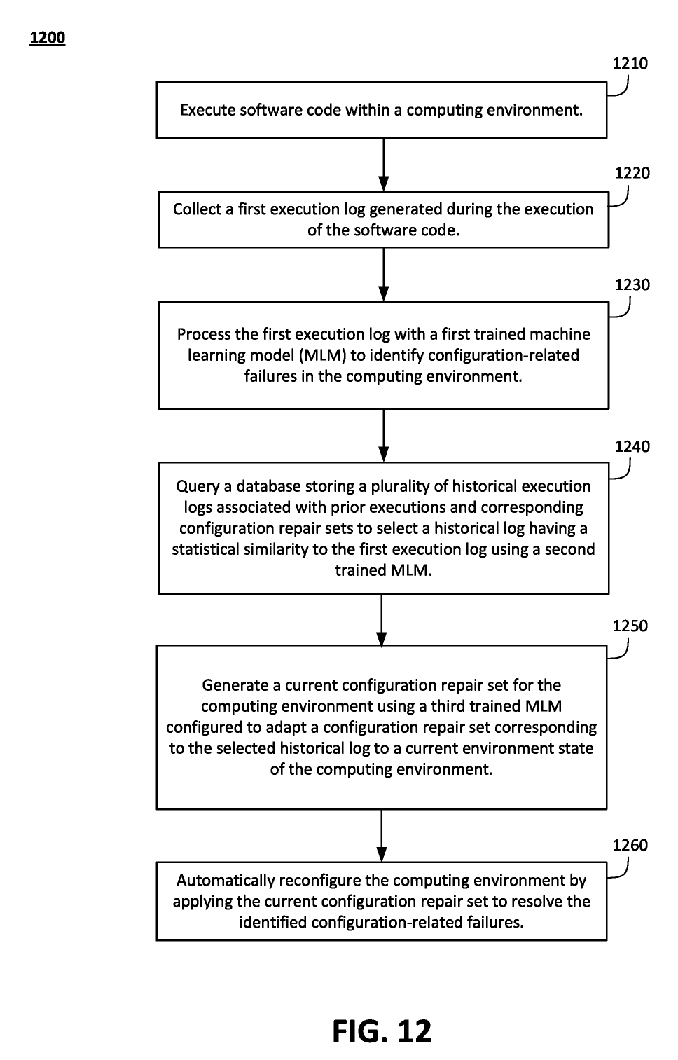

FIG. 12 shows a flowchart illustrating a method 1200 of automated configuration and repair of computing environments according to some aspects of this disclosure. In various implementations, the method 1200 may be performed by a device with one or more processors and non-transitory memory that performs intent prediction. In some implementations, the method 1200 may be performed by processing logic, including hardware, firmware, software, or a combination thereof. In some implementations, the method 1200 may be performed by a processor executing code stored in a non-transitory computer-readable medium (e.g., a memory). The method 1200 may include automatically configuring and repairing computing environments for executing software code.

At 1210, the method 1200 may include executing software code (e.g., software code 701) within a computing environment.

At 1220, the method 1200 may include collecting a first execution log (e.g., first execution log 902) generated during the execution of the software code.

At 1230, the method 1200 may include processing the first execution log with a first trained MLM (e.g., log classification MLM 721) to identify configuration-related failures in the computing environment.

At 1240, the method 1200 may include querying a database (e.g., historical configuration database 750) storing a plurality of historical execution logs associated with prior executions and corresponding configuration repair sets to select a historical log having a statistical similarity to the first execution log using a second trained MLM (e.g., log similarity MLM 722).

At 1250, the method 1200 may include generating a current configuration repair set for the computing environment using a third trained MLM (e.g., repair set generation MLM 723) configured to adapt a configuration repair set corresponding to the selected historical log to a current environment state of the computing environment.

At 1260, the method 1200 may include automatically reconfiguring the computing environment by applying the current configuration repair set to resolve the identified configuration-related failures.

In an aspect, the reconfiguring the computing environment may include: modifying the computing environment based on the current configuration repair set; re-executing the software code within the modified computing environment to collect a second execution log; computing a first error-volume metric from the first execution log and a second error-volume metric from the second execution log; determining a baseline configuration repair set based on a comparison between the first error-volume metric and the second error-volume metric; and further reconfiguring the computing environment based on the baseline configuration repair set until the software code executes successfully or a termination condition is met.

In an aspect, the determining the baseline configuration repair set may include: when the second error-volume metric is less than the first error-volume metric, determining the current configuration repair set as the baseline configuration repair set; and when the second error-volume metric is not less than the first error-volume metric, determining a subsequent configuration repair set as the baseline configuration repair set, the subsequent configuration repair set being generated by the third trained MLM.

In an aspect, at least one of the first and second error-volume metrics may include at least one of a number of errors, a severity of errors, or a distribution of error types.

In an aspect, at least one of the first and second error-volume metrics may be calculated by: assigning error-volume scores to respective error messages in the execution log by using a fourth trained MLM (e.g., error-volume scoring MLM 724) and based on an information source including at least one of an online documentation, a benchmark repository, or a question-and-answer website; and aggregating the error-volume scores to obtain the error-volume metric.

In an aspect, the modifying the computing environment may include modifying at least one of: an installed software package; a version of an interpreter or a library; or an environment variable.

In an aspect, the method 1200 may further include: for each of the prior executions, storing in the database an indication whether a configuration repair set corresponding to the respective prior execution has resolved a corresponding execution failure.

In an aspect, the current configuration repair set may include at least one of a shell script, a package-manager command, or an edit to a configuration file.

In an aspect, the method 1200 may further include: parsing the software code to identify a dependency statement including at least one of an import statement, an include directive, or a package reference; based on the dependency statement, determining a software library used for the execution of the software code; and prior to the execution of the software code, installing the software library in the computing environment.

In an aspect, the method 1200 may further include: generating a test program including the identified dependency statement; executing the test program in the computing environment prior to the execution of the software code; and collecting a test execution log as at least a part of the first execution log.

In an aspect, the method 1200 may further include: identifying initial configuration parameters from at least one of the software code or an associated documentation; and configuring the computing environment based on the initial configuration parameters prior to the execution of the software code.

In an aspect, the initial configuration parameters may include at least one of a software configuration parameter, a hardware configuration parameter, or a runtime configuration parameter.

In an aspect, the associated documentation may include at least one of a README file, a configuration file, or comments embedded in the software code.

In an aspect, the computing environment may include at least one of a virtual machine, a container, or a sandbox.

In an aspect, the method 1200 may further include: identifying a first runtime parameter for the software code from a documentation associated with the software code; executing the software code based on the first runtime parameter to collect a third execution log; using a fifth trained MLM (e.g., parameter inferencing MLM 725) to obtain an inferred parameter based on at least one of the third execution log or a static analysis of the software code; modifying the computing environment based on the inferred parameter; and retaining the inferred parameter when a fourth error-volume metric from a fourth execution log is less than a third error-volume metric from the third execution log.

In an aspect, the static analysis of the software code may include: generating an abstract syntax tree for the software code; from the abstract syntax tree, identifying a code element depending on the first runtime parameter; and using the fifth trained ML model to determine a candidate value for the inferred parameter.

In an aspect, the method 1200 may further include: crawling a source code repository to obtain data including at least one of source code, documentation, or issue reports; using a sixth trained MLM (e.g., fact extraction MLM 726) to extract configuration information from the obtained data; and storing the configuration information in a knowledge base.

In an aspect, the configuration information may include at least one of a supported library version, a required hardware capability, or a known incompatibility.

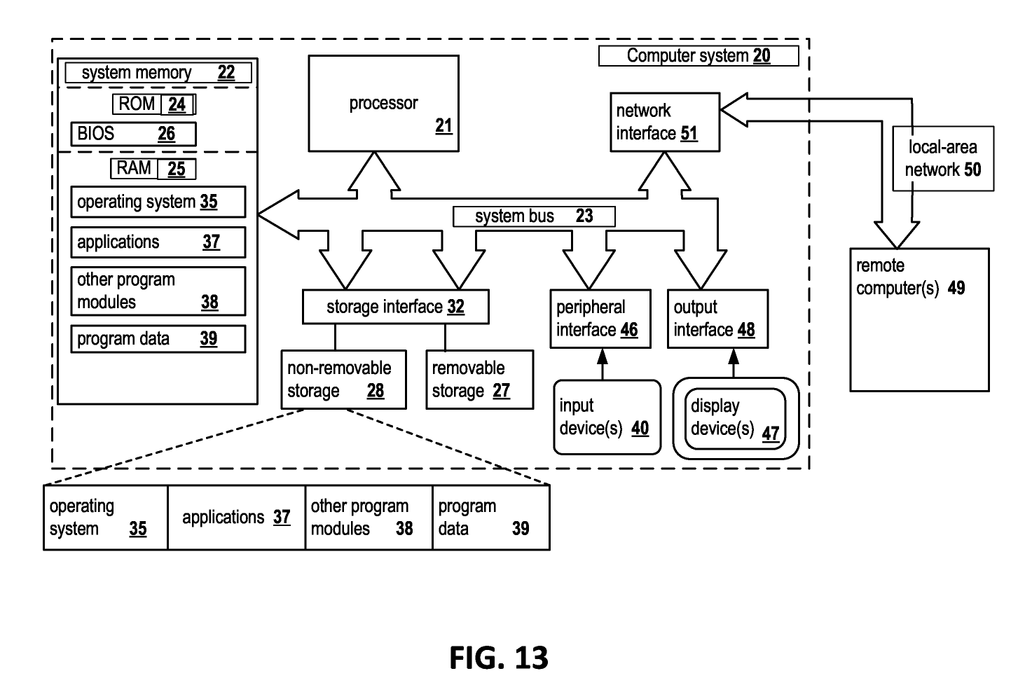

FIG. 13 is a block diagram illustrating a computer system 20 on which aspects of systems and methods machine learning (ML)-based analysis of executing software code associated with scientific or technical documents in a virtual environment may be implemented. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-12 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term "module" as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module’s functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer’s specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A computer-implemented method for automated reconfiguration of computing environments, the method comprising:
executing software code within a computing environment;
collecting a first execution log generated during the execution of the software code;
processing the first execution log with a first trained machine learning model (MLM) to identify configuration-related failures in the computing environment;
querying a database storing a plurality of historical execution logs associated with prior executions and corresponding configuration repair sets to select a historical log having a statistical similarity to the first execution log using a second trained MLM;
generating a current configuration repair set for the computing environment using a third trained MLM configured to adapt a configuration repair set corresponding to the selected historical log to a current environment state of the computing environment; and
automatically reconfiguring the computing environment by applying the current configuration repair set to resolve the identified configuration-related failures.

2. The computer-implemented method of claim 1, wherein the reconfiguring the computing environment includes:
modifying the computing environment based on the current configuration repair set;
re-executing the software code in the modified computing environment to collect a second execution log;
computing a first error-volume metric from the first execution log and a second error-volume metric from the second execution log;
determining a baseline configuration repair set based on a comparison between the first error-volume metric and the second error-volume metric; and
further reconfiguring the computing environment based on the baseline configuration repair set until the software code executes successfully or a termination condition is met.

3. The computer-implemented method of claim 2, wherein the determining the baseline configuration repair set includes:
when the second error-volume metric is less than the first error-volume metric, determining the current configuration repair set as the baseline configuration repair set; and
when the second error-volume metric is not less than the first error-volume metric, determining a subsequent configuration repair set as the baseline configuration repair set, the subsequent configuration repair set being generated by the third trained MLM.

4. The computer-implemented method of claim 2, wherein at least one of the first and second error-volume metrics includes at least one of a number of errors, a severity of errors, or a distribution of error types.

5. The computer-implemented method of claim 2, wherein at least one of the first and second error-volume metrics is calculated by:
assigning error-volume scores to respective error messages in the execution log by using a fourth trained MLM and based on an information source including at least one of an online documentation, a benchmark repository, or a question-and-answer website; and
aggregating the error-volume scores to obtain the error-volume metric.

6. The computer-implemented method of claim 2, wherein the modifying the computing environment includes modifying at least one of: an installed software package; a version of an interpreter or a library; or an environment variable.

7. The computer-implemented method of claim 1, further comprising:
for each of the prior executions, storing in the database an indication whether a configuration repair set corresponding to the respective prior execution has resolved a corresponding execution failure.

8. The computer-implemented method of claim 1, wherein the current configuration repair set includes at least one of a shell script, a package-manager command, or an edition to a configuration file.

9. The computer-implemented method of claim 1, further comprising:
parsing the software code to identify a dependency statement including at least one of an import statement, an include directive, or a package reference;
based on the dependency statement, determining a software library used for the execution of the software code; and
prior to the execution of the software code, installing the software library in the computing environment.

10. The computer-implemented method of claim 9, further comprising:
generating a test program including the identified dependency statement;
executing the test program in the computing environment prior to the execution of the software code; and
collecting a test execution log as at least a part of the execution log.

11. The computer-implemented method of claim 1, further comprising:
identifying initial configuration parameters from at least one of the software code or an associated documentation; and
configuring the computing environment based on the initial configuration parameters prior to the execution of the software code.

12. The computer-implemented method of claim 11, wherein the initial configuration parameters include at least one of a software configuration parameter, a hardware configuration parameter, or a runtime configuration parameter.

13. The computer-implemented method of claim 11, wherein the associated documentation includes at least one of a README file, a configuration file, or comments embedded in the software code.

14. The computer-implemented method of claim 1, further comprising:
identifying a first runtime parameter for the software code from a documentation associated with the software code;
executing the software code based on the first runtime parameter to collect a third execution log;
using a fifth trained MLM to obtain an inferred parameter based on at least one of the third execution log or a static analysis of the software code;
modifying the computing environment based on the inferred parameter; and
retaining the inferred parameter when a fourth error-volume metric from a fourth execution log is less than a third error-volume metric from the third execution log.

15. The computer-implemented method of claim 14, wherein the static analysis of the software code includes:
generating an abstract syntax tree for the software code;
from the abstract syntax tree, identifying a code element depending on the first runtime parameter; and
using the fifth trained MLM to determine a candidate value for the inferred parameter.

16. The computer-implemented method of claim 1, further comprising:
crawling a source code repository to obtain data including at least one of source code, documentation, or issue reports;
using a sixth trained MLM to extract configuration information from the obtained data; and
storing configuration information in a knowledge base.

17. The computer-implemented method of claim 16, wherein the configuration information include at least one of a supported library version, a required hardware capability, or a known incompatibility.

18. The computer-implemented method of claim 1, wherein the computing environment includes at least one of a virtual machine, a container, or a sandbox.

19. A system for automated reconfiguration of computing environments, the system comprising processing circuitry configured to:
execute software code within a computing environment;
collect a first execution log generated during the execution of the software code;
process the first execution log with a first trained machine learning model (MLM) to identify configuration-related failures in the computing environment;
query a database storing a plurality of historical execution logs associated with prior executions and corresponding configuration repair sets to select a historical log having a statistical similarity to the first execution log using a second trained MLM;
generate a current configuration repair set for the computing environment using a third trained MLM configured to adapt a configuration repair set corresponding to the selected historical log to a current environment state of the computing environment; and
automatically reconfigure the computing environment by applying the current configuration repair set to resolve the identified configuration-related failures.

20. A non-transitory computer-readable medium storing thereon computer-executable instructions for automated reconfiguration of computing environments, including instructions for:
executing software code within a computing environment;
collecting a first execution log generated during the execution of the software code;
processing the first execution log with a first trained machine learning model (MLM) to identify configuration-related failures in the computing environment;
querying a database storing a plurality of historical execution logs associated with prior executions and corresponding configuration repair sets to select a historical log having a statistical similarity to the first execution log using a second trained MLM;
generating a current configuration repair set for the computing environment using a third trained MLM configured to adapt a configuration repair set corresponding to the selected historical log to a current environment state of the computing environment; and
automatically reconfiguring the computing environment by applying the current configuration repair set to resolve the identified configuration-related failures.
